(19) United States
(12) Patent Application Publication
(10) Pub. No.: US 2026/0178423 A1
(43) Pub. Date: Jun. 25, 2026

(54) TECHNIQUES FOR IMPROVED PROCESS AVAILABILITY AND DOWNTIME REDUCTION IN CONNECTION WITH CORE DUMPS

(71) Applicant: Dell Products L.P., Hopkinton, MA (US)

(72) Inventors: Dmitry Krivenok, Leopardstown (IE); Alexandra Panina, Dublin (IE)

(73) Assignee: Dell Products L.P., Hopkinton, MA (US)

(21) Appl. No.: 18/990,659

(22) Filed: Dec. 20, 2024

(51) Int. Cl. G06F 9/54

(52) U.S. Cl. CPC G06F 9/541

(57) ABSTRACT

Techniques can include: executing a first process that performs processing including: creating a first socket associated with a first file descriptor; and binding the first socket, as referenced using the first file descriptor, to a port having a port number; the first process crashing including abnormally terminating execution; and in response to the first process crashing, performing second processing including: core dump processing of memory used by the first process; and starting execution of a second process prior to completing the core dump processing for the first process, wherein the second process performs third processing including: creating a second file descriptor of the second process, wherein the second file descriptor is associated with the first socket that is i) referenced using the first file descriptor, and ii) bound to the port; and the second process taking over communications to the port using the second file descriptor and the first socket.

### BACKGROUND

Systems include different resources used by one or more host processors. The resources and the host processors in the system are interconnected by one or more communication connections, such as network connections. These resources include data storage devices such as those included in data storage systems. The data storage systems are typically coupled to one or more host processors and provide storage services to each host processor. Multiple data storage systems from one or more different vendors can be connected to provide common data storage for the one or more host processors.

A host performs a variety of data processing tasks and operations using the data storage system. For example, a host issues I/O operations, such as data read and write operations, that are subsequently received at a data storage system. The host systems store and retrieve data by issuing the I/O operations to the data storage system containing a plurality of host interface units, disk drives (or more generally storage devices), and disk interface units. The host systems access the storage devices through a plurality of channels provided therewith. The host systems provide data and access control information through the channels to a storage device of the data storage system. Data stored on the storage device is provided from the data storage system to the host systems also through the channels. The host systems do not address the storage devices of the data storage system directly, but rather, access what appears to the host systems as a plurality of files, objects, logical units, logical devices or logical volumes. Thus, the I/O operations issued by the host are directed to a particular storage entity, such as a file or logical device. The logical devices generally include physical storage provisioned from portions of one or more physical drives. Allowing multiple host systems to access the single data storage system allows the host systems to share data stored therein.

### SUMMARY OF THE PRESENT DISCLOSURE

Various embodiments of the techniques herein can include a computer-implemented method, a system and a non-transitory computer readable medium. The system can include one or more processors, and a memory comprising code that, when executed, performs the method. The non-transitory computer readable medium can include code stored thereon that, when executed, performs the method. The method can comprise: executing a first process that performs first processing including: creating a first socket associated with a first file descriptor of the first process; and binding the first socket, that is referenced using the first file descriptor, to a port having a port number; the first process crashing including abnormally terminating execution of the first process; and in response to the first process crashing, performing second processing including: performing core dump processing of first memory used by the first process; and starting execution of a second process prior to completing the core dump processing for the first process, wherein the second process performs third processing including: creating a second file descriptor of the second process, wherein the second file descriptor is associated with the first socket that is i) referenced using the first file descriptor, and ii) bound to the port; and the second process taking over communications to the port using the second file descriptor and the first socket.

In at least one embodiment, first resources of the first process can be held and not released until the core dump processing for the first process has completed, and wherein the first resources can include the first socket and the first file descriptor. The first process crashing can be performed after the first process completes the first processing. The first process can be a first instance of a critical process and the second process can be a second instance of the critical process. The second processing can include sending a first process identifier (PID) of the first process after crashing to a core dump helper (CDH). The first PID can be sent from a kernel of an operating system to the CDH and the second processing can include the CDH sending a message to a high availability (HA) manager, wherein the message includes the first PID of the first process that crashed. The second processing can include the HA manager starting execution of the second process including passing the first PID as a parameter to the second process.

In at least one embodiment, the third processing performed by the second process can include: opening, using the first PID passed as the parameter from the HA manager when starting the execution of the second process, a third file descriptor associated with the first process that has crashed; determining that the first file descriptor of the first process is associated with the port having the port number; opening the first file descriptor that is associated with the third file descriptor of the first process that crashed; and performing said creating the second file descriptor of the second process, wherein the second file descriptor is associated with the first socket as referenced using the first file descriptor. The third processing performed by the second process can include: the second process accepting a connection request from a client for the first socket associated with the port; and the second process accepting first content sent from the client to the port associated with the first socket. Determining that the first file descriptor of the first process is associated with the port having the port number can include issuing a first query that determines the first file descriptor based, at least in part, on the first PID, the port number, and a network type. The network type can be any of: TCP (Transmission Control Protocol), and UDP (User Datagram Protocol).

In at least one embodiment, the second processing can include: the HA manager starting the execution of the second process; and the CDH storing the first PID in a file or predetermined location. The third processing performed by the second process can include the second process issuing a bind function call that is intercepted and transfers control to a customized version of the bind function, wherein the bind function call includes first parameters comprising: the second file descriptor of the second process and the port number of the port to be bound. The customized version of the bind function can performs processing including: reading the first PID from the file or predetermined location; opening, using the first PID obtained with said reading, a third file descriptor associated with the first process that has crashed; determining that the first file descriptor of the first process is associated with the port having the port number; opening the first file descriptor that is associated with the third file descriptor of the first process that crashed; creating a fourth file descriptor of the second process, wherein the fourth file descriptor references the first socket associated with the first file descriptor; and updating the second file descriptor, including associating the second file descriptor with the first socket as referenced using the fourth file descriptor. The third processing performed by the second process can include: the second process accepting a connection request from a client for the first socket associated with the port; and the second process accepting first content sent from the client to the port associated with the first socket.

In at least one embodiment, the first socket can be a listening socket, and the method can be performed in a storage system.

In at least one embodiment, processing can include: executing a first process that performs first processing including: creating a first object associated with a first file descriptor of the first process; the first process crashing including abnormally terminating execution of the first process; and in response to the first process crashing, performing second processing including: performing core dump processing of first memory used by the first process; and starting execution of a second process prior to completing the core dump processing for the first process, wherein the second process performs third processing including: creating a second file descriptor of the second process, wherein the second file descriptor is associated with the first object that is referenced using the first file descriptor; and the second process taking over the first object using the second file descriptor. The first object can be any of a pipe, a file, and a socket.

### BRIEF DESCRIPTION OF THE DRAWINGS

Features and advantages of the present disclosure will become more apparent from the following detailed description of exemplary embodiments thereof taken in conjunction with the accompanying drawings in which:

FIG. 1 is an example of components that may be included in a system in accordance with the techniques of the present disclosure.

FIG. 2 is an example illustrating the I/O path or data path in connection with processing data in at least one embodiment in accordance with the techniques of the present disclosure.

FIGS. 3 and 4 are examples illustrating components and associated processing that can be performed in at least one system;

FIGS. 5, 6, 7, 8, 9, 10, 11 and 12 are examples illustrating components and associated processing that can be performed in embodiments in accordance with the techniques of the present disclosure.

FIGS. 13 and 14 are flowcharts of processing steps which can be performed in at least one embodiment in accordance with the techniques of the present disclosure.

### DETAILED DESCRIPTION OF EMBODIMENT(S)

Memory-intensive applications can run on systems, such as data storage systems, and also in public clouds. Such applications can use, for example, hundreds of GBs of memory. Examples of such applications can include i) large in-memory data bases, and ii) data path components of a data storage system. When an executing computer program, such as an application or process, crashes, it can be crucial to collect a related core dump for further analysis to determine potential causes of the crash. When the computer program crashes, the computer program fails, aborts, and/or abnormally stops execution. In response to the crash of the computer program, a core dump can be performed to generally capture the memory state of the computer program at the moment of the crash. A core dump can be performed to generate a core dump file that captures the memory state of the computer program at the moment when the computer program crashes or aborts execution abnormally, essentially acting as a snapshot of the program's memory at the time of the crash. The core dump can be subsequently analyzed in a post-mortem crash analysis by developers to determine the cause of the crash, for example, by examining the program's variables, stack, and registers at the time of the crash. The core dump file can be used, for example, for debugging purposes when a program encounters a fatal error resulting in the program crash.

Core dump generation can take a lot of time and computing resources. In particular, the amount of time and computing resources consumed can increase with the amount of memory utilized by the crashed computer program. The computer program that crashed can be a critical system process or application with strict availability requirements whereby a new instance of the computer program needs to be started as soon as possible after the crash. The core dump generation process, however, can prevent a new instance of the computer program from being started until the core dump of the crashed instance has been completed.

To allow the new instance of the program to commence sooner after the crash, one approach can be to look for ways to speed up the core dump generation process. However, even a large improvement in core dump generation and processing times does not remove the dependency where the core dump generation for the crashed program instance has to complete before the new program instance can commence execution.

Another approach can be to disable core dump generation to enable immediately starting the new instance of the crashed program. However, it can be highly undesirable to disable core dump generation due to the lack of information regarding the memory state of the crashed program. Without a core dump for a crashed program, post-mortem crash analysis can be difficult or even impossible.

There is a significant realm of use-cases where systems have enough memory to accommodate a new instance of the program while the operating system (OS) kernel also performs the core dump generation of the previous instance of the program after the previous instance crashes. However, one problem is that the OS kernel does not release resources of the crashed program instance until its core dump is complete. The most problematic type of resources are network sockets. A new instance of the program cannot start or commence execution before the kernel releases sockets owned by the previous crashed program instance, where such sockets are not released until the corresponding core dump has completed. Thus the crashed process can generally retain ownership of its resources, such as sockets, during the corresponding crash dump processing, whereby such resources owned by the crashed process can be subsequently released once the crash dump processing has completed and the crashed process is completely terminated or exits. With a crashed process, its execution can abnormally terminate or abort but the crashed process does not completely exit the system and fully terminate or complete until the core dump is complete. Once the crashed process is fully terminated or completed, the crashed process releases its owned resources. Thus during the core dump, the crashed process still retains its owned resources such as, for example, sockets of the crashed process.

In some systems, network sockets of a program can be used with an option that allows the new program instance to reuse a resource, such as a port, of the crashed program. With such an option, multiple sockets can be bound to the same port where the multiple sockets can include a first socket of the crashed program instance and a second socket of the new program instance which commences execution after the crash. With the foregoing option, the new program instance can be restarted prior to completion of the corresponding core dump for the crashed instance. However, with the foregoing option, the OS kernel distributes traffic from clients to all such multiple sockets including the first socket of the crashed program, where messages of clients sent to the first socket can lead to the undesirable adverse affect and unreliability of timeouts or lost messages since the owning crashed program is not processing messages sent to its first socket.

Accordingly, the techniques of the present disclosure overcome at least the foregoing problems and limitations. In at least one embodiment, the techniques of the present disclosure allow a new instance of the program to use the same ports, such as the same TCP (Transmission Control Protocol) and/or UDP (User Datagram Protocol) ports, of the crashed program instance before the corresponding core dump of the crashed program instance completes.

The techniques of the present disclosure utilize a novel approach allowing for immediate recovery after a program crash independent of the core dump process and irrespective of the time it takes to complete the core dump process.

In at least one embodiment, the techniques of the present disclosure provide for a significant reduction in the amount of time it takes to commence execution of a new program instance subsequent to terminating execution of a crashed program instance, thereby improving the availability of the program and overall availability of the system.

Unlike other approaches such as speeding up the core dump process, the techniques of the present disclosure in at least one embodiment utilize an approach which i) eliminates dependency on the core dump completion of the crashed instance; ii) allows a new instance of the program to be restarted immediately following a crash; and iii) allows the core dump of the crashed instance to finish in background.

In at least one embodiment, the techniques of the present disclosure enable the new program instance to be started i) using the same ports as the crashed program instance; and ii) prior to the kernel completing the core dump for the crashed instance. Additionally, the foregoing can be performed without adversely impacting clients communicating with the new program instance.

In at least one embodiment where the crashed program and the new program are both different instances of the same program, the techniques of the present disclosure provide for a reduction in down time and increased availability of the program without adversely impacting clients, such as without the unreliable communications including lost messages or timeouts noted above.

The foregoing and other aspects of the techniques of the present disclosure are described in more detail in the following paragraphs.

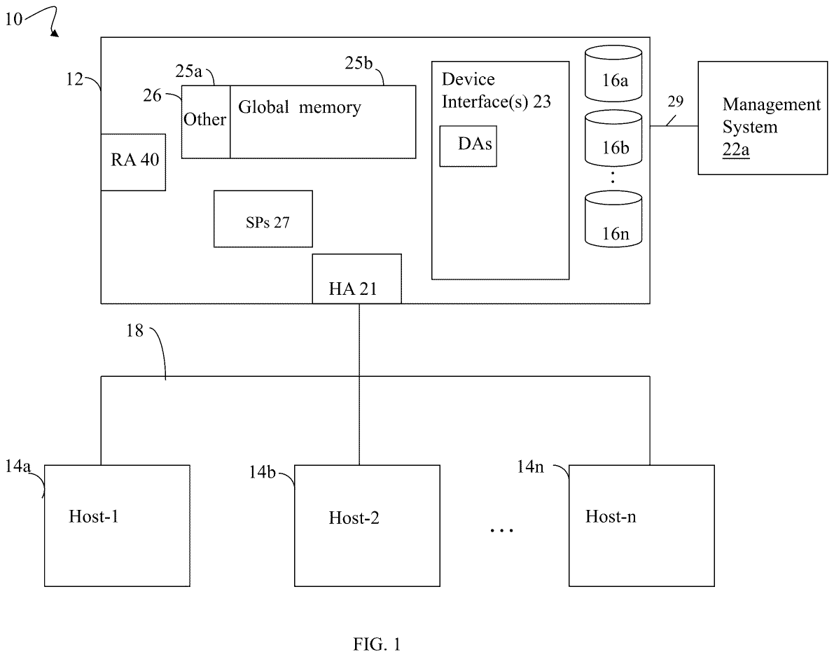

Referring to the FIG. 1, shown is an example of an embodiment of a SAN10 that is used in connection with performing the techniques described herein. The SAN 10 includes a data storage system 12 connected to the host systems (also sometimes referred to as hosts) 14a-14n through the communication medium 18. In this embodiment of the SAN 10, the n hosts 14a-14n access the data storage system 12, for example, in performing input/output (I/O) operations or data requests. The communication medium 18 can be any one or more of a variety of networks or other type of communication connections as known to those skilled in the art. The communication medium 18 can be a network connection, bus, and/or other type of data link, such as a hardwire or other connections known in the art. For example, the communication medium 18 can be the Internet, an intranet, a network, or other wireless or other hardwired connection(s) by which the host systems 14a-14n access and communicate with the data storage system 12, and also communicate with other components included in the SAN 10.

Each of the host systems 14a-14n and the data storage system 12 included in the SAN 10 are connected to the communication medium 18 by any one of a variety of connections as provided and supported in accordance with the type of communication medium 18. The processors included in the host systems 14a-14n and data storage system 12 can be any one of a variety of proprietary or commercially available single or multi-processor system, such as an Intel-based processor, or other type of commercially available processor able to support traffic in accordance with each particular embodiment and application.

It should be noted that the particular examples of the hardware and software included in the data storage system 12 are described herein in more detail, and can vary with each particular embodiment. Each of the hosts 14a-14n and the data storage system 12 can all be located at the same physical site, or, alternatively, be located in different physical locations. The communication medium 18 used for communication between the host systems 14a-14n and the data storage system 12 of the SAN 10 can use a variety of different communication protocols such as block-based protocols (e.g., SCSI, FC, iSCSI), file system-based protocols (e.g., NFS or network file server), and the like. Some or all of the connections by which the hosts 14a-14n and the data storage system 12 are connected to the communication medium 18 can pass through other communication devices, such as switching equipment, a phone line, a repeater, a multiplexer or even a satellite.

Each of the host systems 14a-14n can perform data operations. In the embodiment of the FIG. 1, any one of the host computers 14a-14n issues a data request to the data storage system 12 to perform a data operation. For example, an application executing on one of the host computers 14a-14n performs a read or write operation resulting in one or more data requests to the data storage system 12.

It should be noted that although the element 12 is illustrated as a single data storage system, such as a single data storage array, the element 12 also represents, for example, multiple data storage arrays alone, or in combination with, other data storage devices, systems, appliances, and/or components having suitable connectivity to the SAN 10 in an embodiment using the techniques herein. It should also be noted that an embodiment can include data storage arrays or other components from one or more vendors. In subsequent examples illustrating the techniques herein, reference is made to a single data storage array by a vendor. However, as will be appreciated by those skilled in the art, the techniques herein are applicable for use with other data storage arrays by other vendors and with other components than as described herein for purposes of example.

In at least one embodiment, the data storage system 12 is a data storage appliance or a data storage array including a plurality of data storage devices (PDs) 16a-16n. The data storage devices 16a-16n include one or more types of data storage devices such as, for example, one or more rotating disk drives and/or one or more solid state drives (SSDs). An SSD is a data storage device that uses solid-state memory to store persistent data. SSDs refer to solid state electronics devices as distinguished from electromechanical devices, such as hard drives, having moving parts. Flash devices or flash memory-based SSDs are one type of SSD that contains no moving mechanical parts. In at least one embodiment, the flash devices can be constructed using nonvolatile semiconductor NAND flash memory. The flash devices include, for example, one or more SLC (single level cell) devices and/or MLC (multi level cell) devices.

In at least one embodiment, the data storage system or array includes different types of controllers, adapters or directors, such as an HA 21 (host adapter), RA 40 (remote adapter), and/or device interface(s) 23. Each of the adapters (sometimes also known as controllers, directors or interface components) can be implemented using hardware including a processor with a local memory with code stored thereon for execution in connection with performing different operations. The HAs are used to manage communications and data operations between one or more host systems and the global memory (GM). In an embodiment, the HA is a Fibre Channel Adapter (FA) or other adapter which facilitates host communication. The HA 21 can be characterized as a front end component of the data storage system which receives a request from one of the hosts 14a-n. In at least one embodiment, the data storage array or system includes one or more RAs used, for example, to facilitate communications between data storage arrays. The data storage array also includes one or more device interfaces 23 for facilitating data transfers to/from the data storage devices 16a-16n. The data storage device interfaces 23 include device interface modules, for example, one or more disk adapters (DAs) (e.g., disk controllers) for interfacing with the flash drives or other physical storage devices (e.g., PDS 16a-n). The DAs can also be characterized as back end components of the data storage system which interface with the physical data storage devices.

One or more internal logical communication paths exist between the device interfaces 23, the RAs 40, the HAs 21, and the memory 26. An embodiment, for example, uses one or more internal busses and/or communication modules. In at least one embodiment, the global memory portion 25b is used to facilitate data transfers and other communications between the device interfaces, the HAs and/or the RAs in a data storage array. In one embodiment, the device interfaces 23 performs data operations using a system cache included in the global memory 25b, for example, when communicating with other device interfaces and other components of the data storage array. The other portion 25a is that portion of the memory used in connection with other designations that can vary in accordance with each embodiment.

The particular data storage system as described in this embodiment, or a particular device thereof, such as a disk or particular aspects of a flash device, should not be construed as a limitation. Other types of commercially available data storage systems, as well as processors and hardware controlling access to these particular devices, can also be included in an embodiment.

The host systems 14a-14n provide data and access control information through channels to the storage systems 12, and the storage systems 12 also provide data to the host systems 14a-n also through the channels. The host systems 14a-n do not address the drives or devices 16a-16n of the storage systems directly, but rather access to data is provided to one or more host systems from what the host systems view as a plurality of logical devices, logical volumes (LVs) also referred to herein as logical units (e.g., LUNs). A logical unit (LUN) can be characterized as a disk array or data storage system reference to an amount of storage space that has been formatted and allocated for use to one or more hosts. A logical unit has a logical unit number that is an I/O address for the logical unit. As used herein, a LUN or LUNs refers to the different logical units of storage referenced by such logical unit numbers. The LUNs have storage provisioned from portions of one or more physical disk drives or more generally physical storage devices. For example, one or more LUNs can reside on a single physical disk drive, data of a single LUN can reside on multiple different physical devices, and the like. Data in a single data storage system, such as a single data storage array, can be accessible to multiple hosts allowing the hosts to share the data residing therein. The HAs are used in connection with communications between a data storage array and a host system. The RAs are used in facilitating communications between two data storage arrays. The DAs include one or more types of device interfaced used in connection with facilitating data transfers to/from the associated disk drive(s) and LUN(s) residing thereon. For example, such device interfaces can include a device interface used in connection with facilitating data transfers to/from the associated flash devices and LUN(s) residing thereon. It should be noted that an embodiment can use the same or a different device interface for one or more different types of devices than as described herein. In an embodiment in accordance with the techniques herein, the data storage system as described can be characterized as having one or more logical mapping layers in which a logical device of the data storage system is exposed to the host whereby the logical device is mapped by such mapping layers of the data storage system to one or more physical devices. Additionally, the host can also have one or more additional mapping layers so that, for example, a host side logical device or volume is mapped to one or more data storage system logical devices as presented to the host.

It should be noted that although examples of the techniques herein are made with respect to a physical data storage system and its physical components (e.g., physical hardware for each HA, DA, HA port and the like), the techniques herein can be performed in a physical data storage system including one or more emulated or virtualized components (e.g., emulated or virtualized ports, emulated or virtualized DAs or HAs), and also a virtualized or emulated data storage system including virtualized or emulated components.

Also shown in the FIG. 1 is a management system 22a used to manage and monitor the data storage system 12. In one embodiment, the management system 22a is a computer system which includes data storage system management software or application that executes in a web browser. A data storage system manager can, for example, view information about a current data storage configuration such as LUNs, storage pools, and the like, on a user interface (UI) in a display device of the management system 22a. Alternatively, and more generally, the management software can execute on any suitable processor in any suitable system. For example, the data storage system management software can execute on a processor of the data storage system 12.

Information regarding the data storage system configuration is stored in any suitable data container, such as a database. The data storage system configuration information stored in the database generally describes the various physical and logical entities in the current data storage system configuration. The data storage system configuration information describes, for example, the LUNs configured in the system, properties and status information of the configured LUNs (e.g., LUN storage capacity, unused or available storage capacity of a LUN, consumed or used capacity of a LUN), configured RAID groups, properties and status information of the configured RAID groups (e.g., the RAID level of a RAID group, the particular PDs that are members of the configured RAID group), the PDs in the system, properties and status information about the PDs in the system, local replication configurations and details of existing local replicas (e.g., a schedule or other trigger conditions of when a snapshot is taken of one or more LUNs, identify information regarding existing snapshots for a particular LUN), remote replication configurations (e.g., for a particular LUN on the local data storage system, identify the LUN's corresponding remote counterpart LUN and the remote data storage system on which the remote LUN is located), data storage system performance information such as regarding various storage objects and other entities in the system, and the like.

Consistent with other discussion herein, management commands issued over the control or management path include commands that query or read selected portions of the data storage system configuration, such as information regarding the properties or attributes of one or more LUNs. The management commands also include commands that write, update, or modify the data storage system configuration, such as, for example, to create or provision a new LUN (e.g., which result in modifying one or

more database tables such as to add information for the new LUN), to modify an existing replication schedule or configuration (e.g., which result in updating existing information in one or more database tables for the current replication schedule or configuration), to delete a LUN (e.g., which include deleting the LUN from a table of defined LUNs and also include modifying one or more other database tables to delete any existing snapshots of the LUN being deleted), and the like.

It should be noted that each of the different controllers or adapters, such as each HA, DA, RA, and the like, can be implemented as a hardware component including, for example, one or more processors, one or more forms of memory, and the like. Code can be stored in one or more of the memories of the component for performing processing.

The device interface, such as a DA, performs I/O operations on a physical device or drive 16a-16n. In the following description, data residing on a LUN is accessed by the device interface following a data request in connection with I/O operations. For example, a host issues an I/O operation that is received by the HA 21. The I/O operation identifies a target location from which data is read from, or written to, depending on whether the I/O operation is, respectively, a read or a write operation request. In at least one embodiment using block storage services, the target location of the received I/O operation is expressed in terms of a LUN and logical address or offset location (e.g., LBA or logical block address) on the LUN. Processing is performed on the data storage system to further map the target location of the received I/O operation, expressed in terms of a LUN and logical address or offset location on the LUN, to its corresponding physical storage device (PD) and location on the PD. The DA which services the particular PD performs processing to either read data from, or write data to, the corresponding physical device location for the I/O operation.

It should be noted that an embodiment of a data storage system can include components having different names from that described herein but which perform functions similar to components as described herein. Additionally, components within a single data storage system, and also between data storage systems, can communicate using any suitable technique described herein for exemplary purposes. For example, the element 12 of the FIG. 1 in one embodiment is a data storage system, such as a data storage array, that includes multiple storage processors (SPs). Each of the SPs 27 is a CPU including one or more “cores” or processors and each have their own memory used for communication between the different front end and back end components rather than utilize a global memory accessible to all storage processors. In such embodiments, the memory 26 represents memory of each such storage processor.

Generally, the techniques herein can be used in connection with any suitable storage system, appliance, device, and the like, in which data is stored. For example, an embodiment can implement the techniques herein using a midrange data storage system as well as a higher end or enterprise data storage system.

The data path or I/O path can be characterized as the path or flow of I/O data through a system. For example, the data or I/O path can be the logical flow through hardware and software components or layers in connection with a user, such as an application executing on a host (e.g., more generally, a data storage client) issuing I/O commands (e.g., SCSI-based commands, and/or file-based commands) that read and/or write user data to a data storage system, and also receive a response (possibly including requested data) in connection such I/O commands.

The control path, also sometimes referred to as the management path, can be characterized as the path or flow of data management or control commands through a system. For example, the control or management path is the logical flow through hardware and software components or layers in connection with issuing data storage management command to and/or from a data storage system, and also receiving responses (possibly including requested data) to such control or management commands. For example, with reference to the FIG. 1, the control commands are issued from data storage management software executing on the management system 22a to the data storage system 12. Such commands, for example, establish or modify data services, provision storage, perform user account management, and the like. Consistent with other discussion herein, management commands result in processing that can include reading and/or modifying information in the database storing data storage system configuration information. For example, management commands that read and/or modify the data storage system configuration information in the database can be issued over the control path to provision storage for LUNs, create a snapshot, define conditions of when to create another snapshot, define or establish local and/or remote replication services, define or modify a schedule for snapshot or other data replication services, define a RAID group, obtain data storage management and configuration information for display in a graphical user interface (GUI) of a data storage management program or application, generally modify one or more aspects of a data storage system configuration, list properties and status information regarding LUNs or other storage objects (e.g., physical and/or logical entities in the data storage system), and the like. The data path and control path define two sets of different logical flow paths. In at least some of the data storage system configurations, at least part of the hardware and network connections used for each of the data path and control path differ. For example, although both control path and data path generally use a network for communications, some of the hardware and software used can differ. For example, with reference to the FIG. 1, a data storage system has a separate physical connection 29 from a management system 22a to the data storage system 12 being managed whereby control commands are issued over such a physical connection 29. However, user I/O commands are never issued over such a physical connection 29 provided solely for purposes of connecting the management system to the data storage system. In any case, the data path and control path each define two separate logical flow paths.

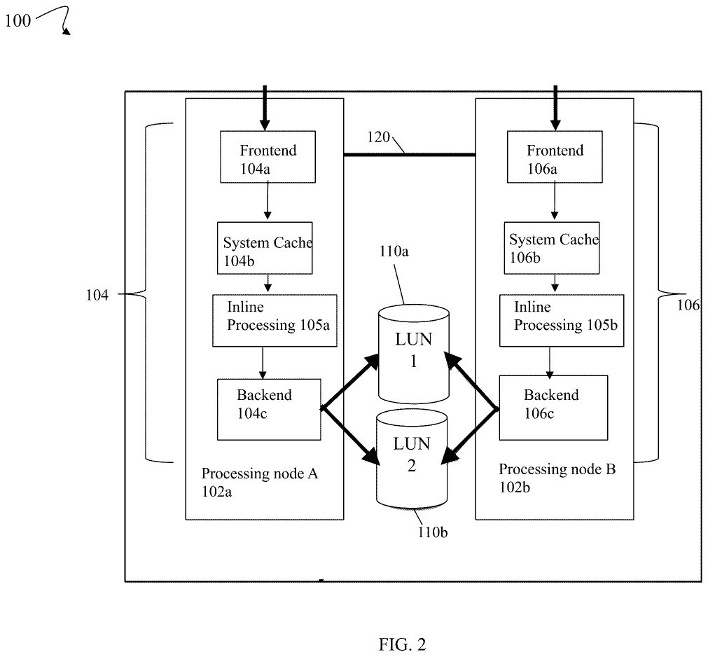

With reference to the FIG. 2, shown is an example 100 illustrating components that can be included in the data path in at least one existing data storage system in accordance with the techniques of the present disclosure. The example 100 includes two processing nodes A 102a and B 102b and the associated software stacks 104, 106 of the data path, where I/O requests can be received by either processing node 102a or 102b. In the example 200, the data path 104 of processing node A 102a includes: the frontend (FE) component 104a (e.g., an FA or front end adapter) that translates the protocol-specific request into a storage system-specific request; a system cache layer 104b where data is temporarily stored; an inline processing layer 105a; and a backend (BE) component 104c that facilitates movement of the data between the system cache and non-volatile physical storage (e.g., back end physical non-volatile storage devices or PDs accessed by BE components such as DAs as described herein). During movement of data in and out of the system cache layer 104b (e.g., such as in connection with read data from, and writing data to, physical storage 110a, 110b), inline processing can be performed by layer 105a. Such inline processing operations of 105a can be optionally performed and can include any one of more data processing operations in connection with data that is flushed from system cache layer 104b to the back-end non-volatile physical storage 110a, 110b, as well as when retrieving data from the back-end non-volatile physical storage 110a, 110b to be stored in the system cache layer 104b. In at least one embodiment, the inline processing can include, for example, performing one or more data reduction operations such as data deduplication or data compression. The inline processing can include performing any suitable or desirable data processing operations as part of the I/O or data path.

In a manner similar to that as described for data path 104, the data path 106 for processing node B 102b has its own FE component 106a, system cache layer 106b, inline processing layer 105b, and BE component 106c that are respectively similar to the components 104a, 104b, 105a and 104c. The elements 110a, 110b denote the non-volatile BE physical storage provisioned from PDs for the LUNs, whereby an I/O can be directed to a location or logical address of a LUN and where data can be read from, or written to, the logical address. The LUNs 110a, 110b are examples of storage objects representing logical storage entities included in an existing data storage system configuration. Since, in this example, writes, or more generally I/Os, directed to the LUNs 110a, 110b can be received for processing by either of the nodes 102a and 102b, the example 100 illustrates what can also be referred to as an active-active configuration.

In connection with a write operation received from a host and processed by the processing node A 102a, the write data can be written to the system cache 104b, marked as write pending (WP) denoting it needs to be written to the physical storage 110a, 110b and, at a later point in time, the write data can be destaged or flushed from the system cache to the physical storage 110a, 110b by the BE component 104c. The write request can be considered complete once the write data has been stored in the system cache whereby an acknowledgement regarding the completion can be returned to the host (e.g., by component the 104a). At various points in time, the WP data stored in the system cache is flushed or written out to the physical storage 110a, 110b.

In connection with the inline processing layer 105a, prior to storing the original data on the physical storage 110a, 110b, one or more data reduction operations can be performed. For example, the inline processing can include performing data compression processing, data deduplication processing, and the like, that can convert the original data (as stored in the system cache prior to inline processing) to a resulting representation or form which is then written to the physical storage 110a, 110b.

In connection with a read operation to read a block of data, a determination is made as to whether the requested read data block is stored in its original form (in system cache 104b or on physical storage 110a, 110b), or whether the requested read data block is stored in a different modified form or representation. If the requested read data block (which is stored in its original form) is in the system cache, the read data block is retrieved from the system cache 104b and returned to the host. Otherwise, if the requested read data block is not in the system cache 104b but is stored on the physical storage 110a, 110b in its original form, the requested data block is read by the BE component 104c from the backend storage 110a, 110b, stored in the system cache and then returned to the host.

If the requested read data block is not stored in its original form, the original form of the read data block is recreated and stored in the system cache in its original form so that it can be returned to the host. Thus, requested read data stored on physical storage 110a, 110b can be stored in a modified form where processing is performed by 105a to restore or convert the modified form of the data to its original data form prior to returning the requested read data to the host.

Also illustrated in FIG. 2 is an internal network interconnect 120 between the nodes 102a, 102b. In at least one embodiment, the interconnect 120 can be used for internode communication between the nodes 102a, 102b.

In connection with at least one embodiment in accordance with the techniques of the present disclosure, each processor or CPU can include its own private dedicated CPU cache (also sometimes referred to as processor cache) that is not shared with other processors. In at least one embodiment, the CPU cache, as in general with cache memory, can be a form of fast memory (relatively faster than main memory which can be a form of RAM). In at least one embodiment, the CPU or processor cache is on the same die or chip as the processor and typically, like cache memory in general, is far more expensive to produce than normal RAM used as main memory. The processor cache can be substantially faster than the system RAM used as main memory. The processor cache can contain information that the processor will be immediately and repeatedly accessing. The faster memory of the CPU cache can for example, run at a refresh rate that's closer to the CPU's clock speed, which minimizes wasted cycles. In at least one embodiment, there can be two or more levels (e.g., L1, L2 and L3) of cache. The CPU or processor cache can include at least an L1 level cache that is the local or private CPU cache dedicated for use only by that particular processor. The two or more levels of cache in a system can also include at least one other level of cache (LLC or lower level cache) that is shared among the different CPUs. The L1 level cache serving as the dedicated CPU cache of a processor can be the closest of all cache levels (e.g., L1-L3) to the processor which stores copies of the data from frequently used main memory locations. Thus, the system cache as described herein can include the CPU cache (e.g., the L1 level cache or dedicated private CPU/processor cache) as well as other cache levels (e.g., the LLC) as described herein. Portions of the LLC can be used, for example, to initially cache write data which is then flushed to the backend physical storage such as BE PDs providing non-volatile storage. For example, in at least one embodiment, a RAM based memory can be one of the caching layers used as to cache the write data that is then flushed to the backend physical storage. When the processor performs processing, such as in connection with the inline processing 105a, 105b as noted above, data can be loaded from the main memory and/or other lower cache levels into its CPU cache.

In at least one embodiment, the data storage system can be configured to include one or more pairs of nodes, where each pair of nodes can be generally as described and represented as the nodes 102a-b in the FIG. 2. For example, a data storage system can be configured to include at least one pair of nodes and at most a maximum number of node pairs, such as for example, a maximum of 4 node pairs. The maximum number of node pairs can vary with embodiment. In at least one embodiment, a base enclosure can include the minimum single pair of nodes and up to a specified maximum number of PDs. In some embodiments, a single base enclosure can be scaled up to have additional BE non-volatile storage using one or more expansion enclosures, where each expansion enclosure can include a number of additional PDs. Further, in some embodiments, multiple base enclosures can be grouped together in a load-balancing cluster to provide up to the maximum number of node pairs. Consistent with other discussion herein, each node can include one or more processors and memory. In at least one embodiment, each node can include two multi-core processors with each processor of the node having a core count of between 8 and 28 cores. In at least one embodiment, the PDs can all be non-volatile SSDs, such as flash-based storage devices and storage class memory (SCM) devices. It should be noted that the two nodes configured as a pair can also sometimes be referred to as peer nodes. For example, the node A 102a is the peer node of the node B 102b, and the node B 102b is the peer node of the node A 102a.

In at least one embodiment, the data storage system can be configured to provide both block and file storage services with a system software stack that includes an operating system running directly on the processors of the nodes of the system.

In at least one embodiment, the data storage system can be configured to provide block-only storage services (e.g., no file storage services). A hypervisor can be installed on each of the nodes to provide a virtualized environment of virtual machines (VMs). The system software stack can execute in the virtualized environment deployed on the hypervisor. The system software stack (sometimes referred to as the software stack or stack) can include an operating system running in the context of a VM of the virtualized environment. Additional software components can be included in the system software stack and can also execute in the context of a VM of the virtualized environment.

In at least one embodiment, each pair of nodes can be configured in an active-active configuration as described elsewhere herein, such as in connection with FIG. 2, where each node of the pair has access to the same PDs providing BE storage for high availability. With the active-active configuration of each pair of nodes, both nodes of the pair process I/O operations or commands and also transfer data to and from the BE PDs attached to the pair. In at least one embodiment, BE PDs attached to one pair of nodes are not shared with other pairs of nodes. A host can access data stored on a BE PD through the node pair associated with or attached to the PD.

In at least one embodiment, each pair of nodes provides a dual node architecture where both nodes of the pair can be generally identical in terms of hardware and software for redundancy and high availability. Consistent with other discussion herein, each node of a pair can perform processing of the different components (e.g., FA, DA, and the like) in the data path or I/O path as well as the control or management path. Thus, in such an embodiment, different components, such as the FA, DA and the like of FIG. 1, can denote logical or functional components implemented by code executing on the one or more processors of each node. Each node of the pair can include its own resources such as its own local (i.e., used only by the node) resources such as local processor(s), local memory, and the like.

As noted above, memory-intensive applications can run on systems, such as data storage systems, and also in public clouds. Such applications can use, for example, hundreds of GBs of memory. Examples of such applications can include i) large in-memory data bases, and ii) data path components of a data storage system. When an executing computer program, such as an application or process, crashes, it can be crucial to collect a related core dump for further analysis to determine potential causes of the crash. When the computer program crashes, the computer program fails, aborts, and/or abnormally stops execution. In response to the crash of the computer program, a core dump can be performed to generally capture the memory state of the computer program at the moment of the crash. A core dump can be performed to generate a core dump file that captures the memory state of the computer program at the moment when the computer program crashes or aborts execution abnormally, essentially acting as a snapshot of the program's memory at the time of the crash. The core dump can be subsequently analyzed in a post-mortem crash analysis by developers to determine the cause of the crash, for example, by examining the program's variables, stack, and registers at the time of the crash. The core dump file can be used, for example, for debugging purposes when a program encounters a fatal error resulting in the program crash.

Core dump generation can take a lot of time and computing resources. In particular, the amount of time and computing resources consumed can increase with the amount of memory utilized by the crashed computer program. The computer program that crashed can be a critical system process or application with strict availability requirements whereby a new instance of the computer program needs to be started as soon as possible after the crash. The core dump generation process, however, can prevent a new instance of the computer program from being started until the core dump of the crashed instance has been completed.

To allow the new instance of the program to commence sooner after the crash, one approach can be to look for ways to speed up the core dump generation process. However, even a large improvement in core dump generation and processing times does not remove the dependency where the core dump generation for the crashed program instance has to complete before the new program instance can commence execution.

Another approach can be to disable core dump generation to enable immediately starting the new instance of the crashed program. However, it can be highly undesirable to disable core dump generation due to the lack of information regarding the memory state of the crashed program. Without a core dump for a crashed program, post-mortem crash analysis can be difficult or even impossible.

There is a significant realm of use-cases where systems have enough memory to accommodate a new instance of the program while the operating system (OS) kernel also performs the core dump generation of the previous instance of the program after the previous instance crashes. However, one problem is that the OS kernel does not release resources of the crashed program instance until its core dump is complete. The most problematic type of resources are network sockets. A new instance of the program cannot start or commence execution before the kernel releases sockets owned by the previous crashed program instance, where such sockets are not released until the corresponding core dump has completed. Thus the crashed process can generally retain ownership of its resources, such as sockets, during the corresponding crash dump processing, whereby such resources owned by the crashed process can be subsequently released once the crash dump processing has completed and the crashed process is completely terminated or exits. With a crashed process, its execution can abnormally terminate or abort but the crashed process does not completely exit the system and fully terminate or complete until the core dump is complete. Once the crashed process is fully terminated or completed, the crashed process releases its owned resources. Thus during the core dump, the crashed process still retains its owned resources such as, for example, sockets of the crashed process.

In some systems, network sockets of a program can be used with an option that allows the new program instance to reuse a resource, such as a port, of the crashed program. With such an option, multiple sockets can be bound to the same port where the multiple sockets can include a first socket of the crashed program instance and a second socket of the new program instance which commences execution after the crash. With the foregoing option, the new program instance can be restarted prior to completion of the corresponding core dump for the crashed instance. However, with the foregoing option, the OS kernel distributes traffic from clients to all such multiple sockets including the first socket of the crashed program, where messages of clients sent to the first socket can lead to the undesirable adverse affect and unreliability of timeouts or lost messages since the owning crashed program is not processing messages sent to its first socket.

Accordingly, the techniques of the present disclosure overcome at least the foregoing problems and limitations. In at least one embodiment, the techniques of the present disclosure allow a new instance of the program to use the same ports, such as the same TCP (Transmission Control Protocol) and/or UDP (User Datagram Protocol) ports, of the crashed program instance before the corresponding core dump of the crashed program instance completes.

The techniques of the present disclosure utilize a novel approach allowing for immediate recovery after a program crash independent of the core dump process and irrespective of the time it takes to complete the core dump process.

In at least one embodiment, the techniques of the present disclosure provide for a significant reduction in the amount of time it takes to commence execution of a new program instance subsequent to terminating execution of a crashed program instance, thereby improving the availability of the program and overall availability of the system.

Unlike other approaches such as speeding up the core dump process, the techniques of the present disclosure in at least one embodiment utilize an approach which i) eliminates dependency on the core dump completion of the crashed instance; ii) allows a new instance of the program to be restarted immediately following a crash; and iii) allows the core dump of the crashed instance to finish in background.

In at least one embodiment, the techniques of the present disclosure enable the new program instance to be started i) using the same ports as the crashed program instance; and ii) prior to the kernel completing the core dump for the crashed instance. Additionally, the foregoing can be performed without adversely impacting clients communicating with the new program instance. In at least one embodiment where the crashed program and the new program are both different instances of the same program, the techniques of the present disclosure provide for a reduction in down time and increased availability of the program without adversely impacting clients, such as without the unreliable communications including lost messages or timeouts noted above.

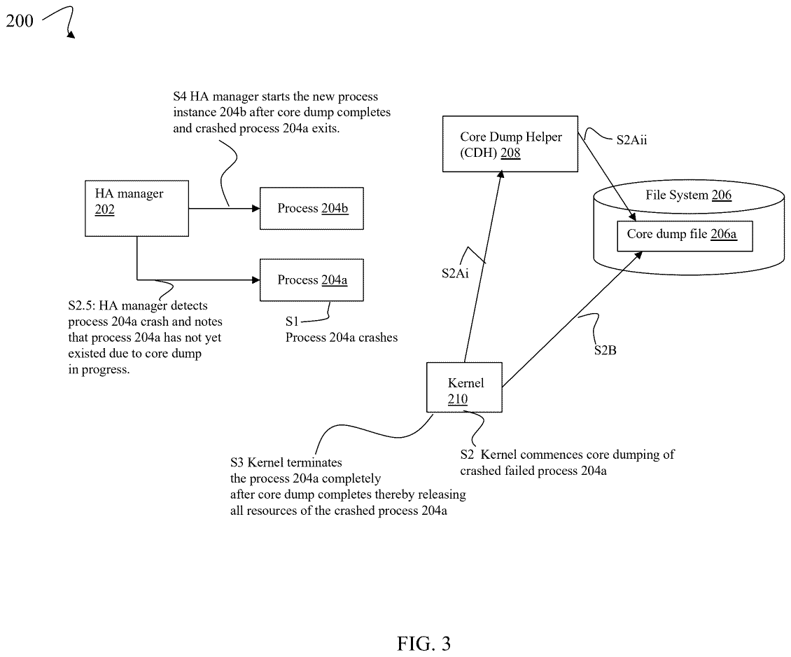

What will now be described with reference to FIG. 3 is an example 200 illustrating processing performed in connection with a core dump. For illustration purposes, consider a critical system process 204a under the control of an HA (high availability) manager 202, where the HA manager 202 is responsible for starting, monitoring and restarting a new instance of the process in case a current instance of the process fails or crashes. The HA manager can monitor the health or status of the process 204a. When the process 204a crashes, such as due to a bug or error, depending on the configuration, one of the following 3 actions can generally be performed: i) the core dump may not be saved if the core dump functionality is disabled; ii) the core dump can be saved to a file in the file system; and iii) the core dump contents can be piped or sent to a user-space core dump helper (CDH) process, where the CDH can perform preprocessing and then save the core dump contents in persistent storage.

In at least one embodiment, when the process 204a crashes, its execution can abnormally or unexpectedly terminate or abort. However, although the execution of the process 204a terminates in the crash, the state of process 204a can be further characterized as not fully terminated during any corresponding core dump performed by the kernel since the process 204a can retain its resources during the corresponding core dump. Once the corresponding core dump for the crashed process 204a is complete, the kernel can perform additional processing to fully or completely terminate all aspects of the process 204a including releasing all resources of the crashed process 204a. Put another way in at least one embodiment, when the process 204a crashes, it can be characterized as being in a crashed state where i) its execution abnormally or unexpectedly terminates; and ii) where additional processing can be performed, such as by or under the control of the kernel, prior to fully terminating all aspects of the process 204a. Such additional processing can include i) performing core dump processing for the crashed process 204a; and ii) releasing resources owned by the crashed process 204a once the core dump processing is complete. Once the additional processing is complete, the crashed process 204a can be characterized as fully terminated or complete. Thus when in the crashed state, the process 204a can be characterized as not fully terminated with respect to other aspects besides its execution since, for example, the crashed process 204a retains its resources when in the crashed state and then releases its resources in the full termination or completion state.

Elements 204a and 204b can denote different instances of the same process where element 204a can denote the crashed process instance and element 204b can denote the new process instance started in connection with processing discussed below. In at least one embodiment such as where the process 204a is an instance of a critical process, it can be desirable to reduce or limit the down time and unavailability of the critical process should the currently running process instance 204a crash and thereby become unavailable for communicating with clients. In at least one embodiment, the CDH can more generally be a tool or other process that facilitates persistently storing the core dump contents to a desired location where the CDH can additionally and optionally perform any desired processing of the core dump contents prior to storing.

With reference to FIG. 3, the process 204a can crash in a step S1. In response to the process 204a crashing S1, the kernel 210 can commence core dumping (S2) for the crashed failed process 204a. Consistent with discussion above depending on the option setting and configuration in connection with the core dumping of S2, the core dump contents can be piped or sent (S2Ai) to the CDH 208 where, in turn, the CDH 208 can then write (S2Aii) the core dump contents to a file, such as the core dump file 206a of the file system 206, or other persistent location. In at least one embodiment, the CDH can also optionally perform preprocessing of the core dump contents prior to storing in the file 206a in S2Aii. For example, such preprocessing of S2Aii can include any one or more of the following: i) filtering or removal of sensitive information or user data (e.g., removal of personal user data such as banking information, social security number, and the like), and ii) compression. As an alternative to performing the steps S2Ai and S2Aii in connection with the core dump of S2, the kernel 210 can directly write (S2B) the core dump contents to the core dump file 206a.

If core dump processing is enabled for the crashed process 204a, then resources of the crashed process 204a will not be released until the corresponding core dump of S2 is complete. Such resources of the crashed process 204a not released until the corresponding core dump of S2 has completed can include network sockets allocated to and used by the process 204a. Such resources of the crashed process 204a not released until the corresponding core dump of S2 is complete can also include, for example, memory and/or file descriptors allocated to and used by the process 204a.

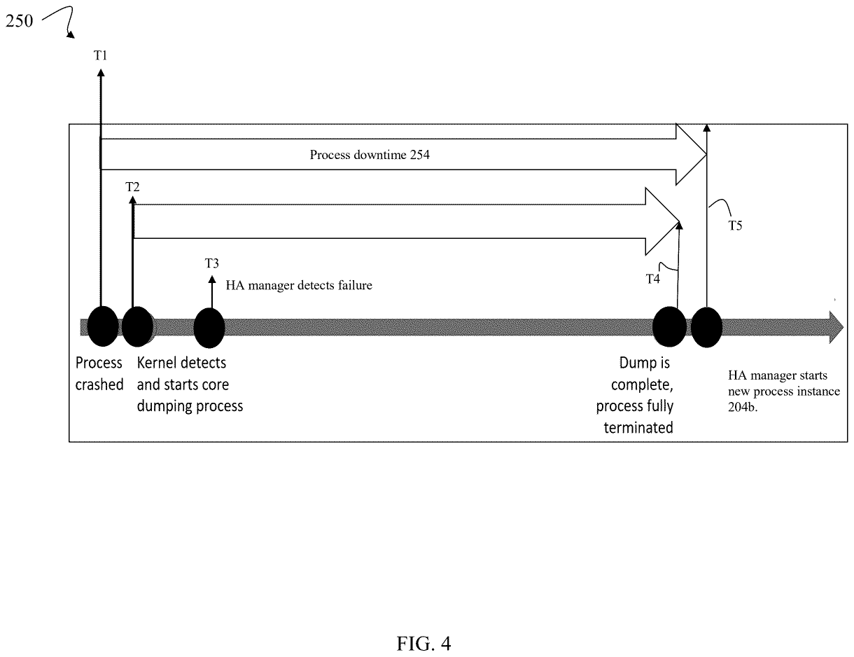

The HA manager 202 can use process-specific monitoring capabilities to detect (S2.5) that the process 204a has crashed sometime after the occurrence of the crash of the process 204a. However, the HA manager 202 does not restart the process by commencing execution a new process instance 204b until the core dump for the crashed process instance 204a has completed. After the core dump of S2 completes, the kernel terminates (S3) the process 204a completely, whereby the process 204a has exited/has an exit status and all resources of the crashed process 204a are released. After the core dump of S2 has completed and the crashed process 204a has exited in S3, the HA manager starts execution (S4) of the new process instance 204b. Based on the foregoing as illustrated in FIG. 3 where the new process instance 204b is not started until the core dump for the crashed process instance 204a has completed, a timeline can result as illustrated in the example 250 of FIG. 4.

In FIG. 4, time T1 can denote the point in time when the process 204a crashes (e.g., S1 of FIG. 3). Time T2 can denote the point in time when the kernel detects and starts the core dumping process (e.g., S2 of FIG. 3) in response to the crash of process 204a. Time T3 can denote the point in time when the HA manager detects the failure or crash of the process 204a (e.g., S2.5 of FIG. 3). Time T4 can denote the point in time when the corresponding core dump is completed and the crashed process 204a has fully terminated or exited. Time T5 can denote the point in time when the HA manager starts the new process instances 204b (e.g., S4 of FIG. 3). Thus in the example 250, the process downtime 254 can be measured as the time difference between T5 and T1, and the core dump time 252 can be measured as the time difference between T4 and T2. In the example 250, the process downtime 254 is larger than the core dump time 252 due to the dependency where the new process instance is not started until completion of the core dump processing. In contrast to the foregoing, following is an example illustrating use of the techniques of the present disclosure in at least one embodiment.

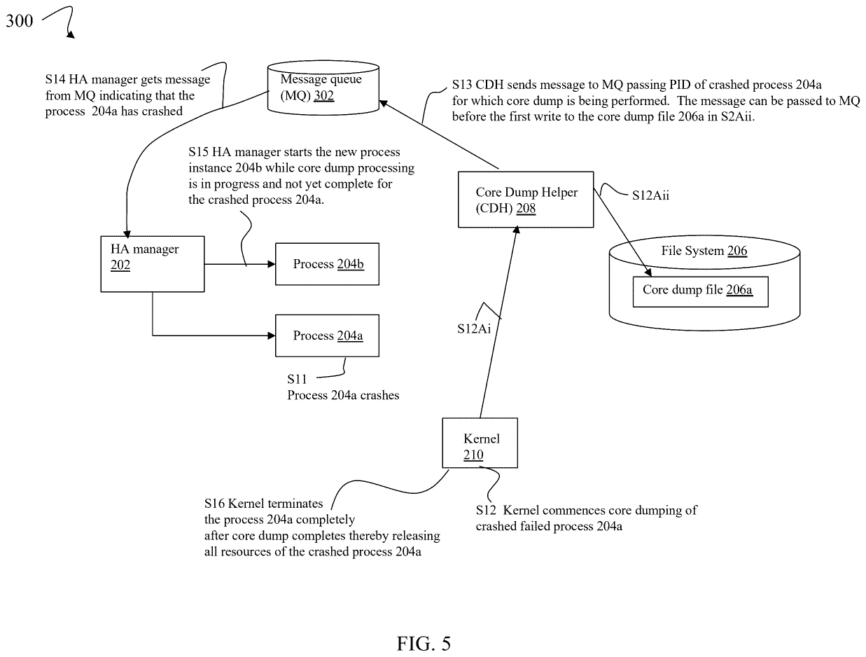

Referring to FIG. 5, shown is an example 300 illustrating components in connection with at least one embodiment of the techniques of the present disclosure.

Components of FIG. 5 include components of FIG. 4 as denoted using the same element numbers with differences discussed below in connection with FIG. 5 processing and the additional message queue (MQ) 302. The HA manager 202 can perform processing to manage the process 204a as discussed above in connection with FIG. 4. In at least one embodiment, the process 204a can denote a first instance of a critical process and the process 204b can denote a new second instance of the critical process. For example, the process can be a server process that receives connection requests and content or data from clients. The process can be critical in that, for example, it performs critical or important services for clients. It can be important that the critical process have high availability with minimal downtime. As a result, if a first instance 204a of the critical process crashes, it can be important for another instance 204b of the critical process to start running as soon as possible thereby minimizing any downtime between the crashed program instances 204a and the restarted program instance 204b.

In the step S11, the process 204a can crash. In response to S11, the kernel 210 commences (S12) core dump processing for the failed crashed process 204a. The step S12 can include performing the step S12Ai where the kernel 210 pipes or sends the core dump contents to the CDH 208 as discussed above in connection with S2Ai of FIG. 3. Additionally, the step S12 can include the step S12Aii (which is similar to the step S2Aii of FIG. 3) where the CDH 208 writes the core dump contents to the core dump file 206a of the file system 206. The step S12Aii can write core dump content received by the CDH in S12Ai. In at least one embodiment, the step S12Aii can include the CDH 208 optionally performing preprocessing such as also discussed above in S2Aii of FIG. 3. Additionally, subsequent to the kernel commencing core dump processing (S12) for the crashed process 204a, the CDH 208 sends (S13) a message to MQ 302 passing the process identifier or ID (PID) of the crashed process 204a for which core dump processing is being performed.

In at least one embodiment, the CDH can send (S13) the message to MQ 302 in response to receiving the first or initial portion of core dump content in S12Ai. In at least one embodiment, the message can be passed from the CDH 208 to MQ 302 prior to the first or initial write of corresponding core dump content to the core dump file 206a in S12Aii. In at least one embodiment, the HA manager 202 can monitor MQ 302 for incoming messages. In response to performing S13 where the CDH sends the message to MQ passing the PID of the crashed process 204a, the HA manager 202 can retrieve or receive (S14) the message from MQ with the PID of the crashed process 204a. From the message including the PID of the crashed process 204a, the HA manager 202 is notified of the particular process instance 204a that crashed. In response to receiving or retrieving the message with the PID in S4, the HA manager 202 can start (S15) the new process instance 204b while core dump processing is in progress and not yet complete for the crashed process 204a.

At some point in time following S15, the kernel terminates (S16) the process 204a completely after the completion of the core dump thereby releasing all resources of the crashed process 204a.

One difference between the embodiments of FIGS. 3 and 5 is that in FIG. 5, the CDH 208 and HA manager 202 are connected or communicatively coupled via the MQ 302 which enables the HA manager to receive immediate notification from the CDH when the corresponding core dump begins. Another difference between the embodiments of FIGS. 3 and 5 is that in FIG. 5, the HA manager can start or commence execution of the new process instance 204b immediately in response to receiving the message, via MQ, from the CDH, where the message includes the PID of the crashed process to have a new process instance started. As a result of the foregoing differences, the techniques of the present disclosure provide for a much shorter downtime of the crashed process, whereby starting the new process instance (e.g., restarting the crashed process) is no longer tied to or dependent on completion of the corresponding core dump.

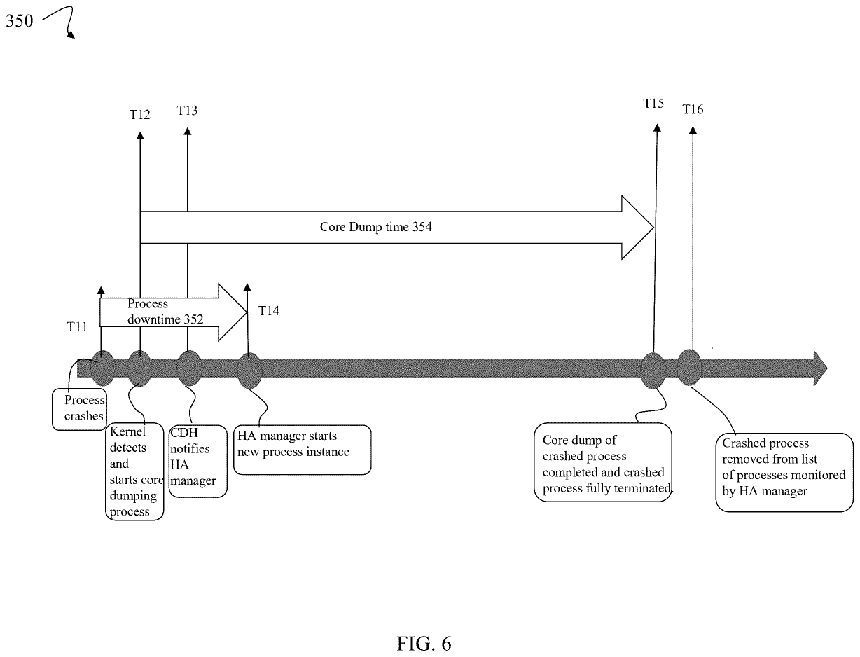

Referring to FIG. 6, shown is an example 300 illustrating a timeline in connection with performing processing as described in FIG. 4 in at least one embodiment in accordance with the techniques of the present disclosure.

In FIG. 6, time T11 can denote the point in time when the process 204a crashes (e.g., S11 of FIG. 5). Time T12 can denote the point in time when the kernel detects and starts the core dumping process (e.g., S12 of FIG. 5) in response to the crash of process 204a. Time T13 can denote the point in time when the CDH notifies (e.g., S13 and S14 of FIG. 5) the HA manager, via the message sent to MQ, regarding the crashed process instance 204a. Time T14 can denote the point in time when the HA manager starts the new process instance 204b (e.g., S15 of FIG. 5). Time T15 can denote the point in time when the corresponding core dump is completed and the crashed process 204a has fully terminated or exited. After the core dump of S12 completes, the kernel terminates (S16) the process 204a completely, whereby the process 204a has exited/has an exit status and all resources of the crashed process 204a are released. At time T16, the crashed process 204a can be removed from the list of processes monitored and managed by the HA manager 202. Thus in the example 350, the process downtime 352 can be measured as the time difference between T14 and T11, and the core dump time 354 can be measured as the time difference between T15 and T12. As can be seen, the process downtime 352 (of FIG. 6) using the techniques of the present disclosure is much less than the process downtime 254 (of FIG. 4) without using the techniques of the present disclosure. In the embodiment of FIG. 5 as illustrated in FIG. 6, the process down time 352 is decoupled or not dependent on the core dump processing time 354 and its completion.

In at least one embodiment, one challenge is enabling the new process instance 204b to commence or start execution in S15 using the same communication or network ports, such as TCP and/or UDP ports, as the crashed process instance 204a before the kernel finishes the corresponding core dump processing for the crashed process instance 204a, while also ensuring that the presence of the old crashed process instance 204a holding resources (e.g., TCP and/or UDP sockets) will not adversely impact clients communicating with the new process instance 204b.

In at least one embodiment, a file descriptor or FD (also referred to herein as a regular file descriptor) is generally a process-unique identifier or handle for an object, where the object can be an I/O (input/output) resource, such as a socket. In at least one embodiment more generally, a regular FD can be associated with an object that is one of the supported object types, where the supported object types include a socket. The supported object types can also include one or more other suitable object types such as any of a file and/or pipe. Accordingly, although the following paragraphs describe embodiments where the regular file descriptor is associated with a socket, the techniques of the present disclosure can also be used in connection with other regular file descriptor object types such as, for example, a pipe, a file or other I/O resource.

In at least one embodiment, the techniques of the present disclosure can utilize a file descriptor passing mechanism of the operating system. In at least one embodiment of a UNIX® operating system, the file descriptor passing mechanism can use a special type of file descriptor, a pidfd, which is a special type of file descriptor that refers to, or is associated with, an existing process as the underlying object (e.g., rather than other types of underlying objects that can be associated with a regular file descriptor). In at least one embodiment, the file descriptor passing mechanism such as pidfd can allow any process with appropriate permissions to get access to any open file descriptor of another process regardless of the underlying object or resource associated with the file descriptor. The foregoing using the file descriptor passing mechanism can be performed by a first process, such as the new process instance 204b, to access an open existing file descriptor of another process, such as the crashed process instance 204a, where the existing file descriptor of the crashed process instance 204a can be bound to or associated with a socket, or more generally any suitable supported object (e.g., file, socket, pipe, and the like). In at least one embodiment, the file descriptor passing mechanism such as pidfd can use the PID of the target process (e.g., such as 204a) and the desired file descriptor number within that process 204a (e.g., where the desired descriptor number can identify a regular file descriptor D2 of the target process PID, where D2 is associated with a socket that will be used by the new process instance 204b).

In at least one embodiment, the special file descriptor pidfd may only be used to obtain or access regular file descriptors of the other existing target process, such as the crashed process instance 204a. In at least one embodiment, the special file descriptor pidfd cannot be used to perform other operations that are performed in connection with a regular file descriptor. For example, the pidfd cannot be used to read or write content or messages.

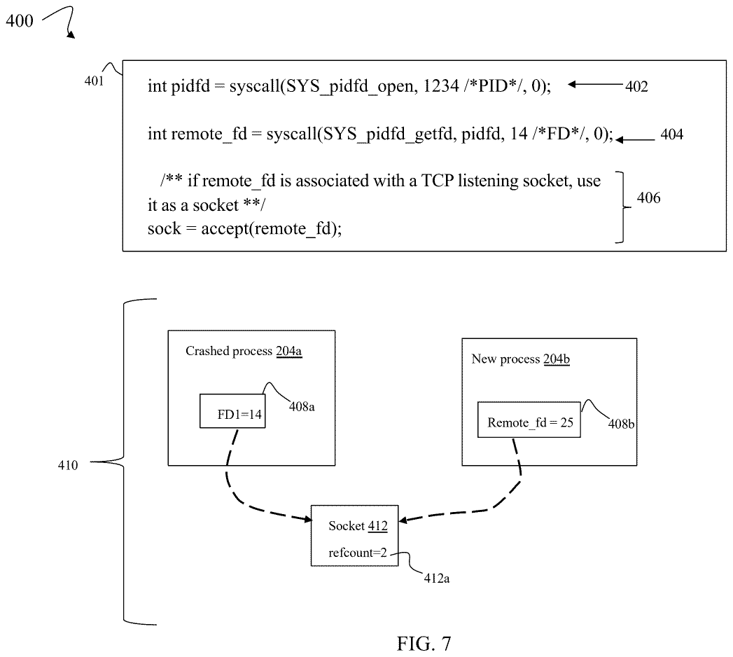

As discussed below and with reference to FIG. 7, the pseudo code 401 of the example 400 of FIG. 7 illustrates the file descriptor passing mechanism that can be used in at least one embodiment to steal or take over one or more objects or resources associated with one or more relevant regular file descriptors from the previous instance of the crashed process 204a while the core dump is still in progress. In this state, the crashed process 204a is completely frozen and not executing and hence, it is safe to take over the crashed process's resources, such as sockets, and continue handling processing associated with them in the new process instance 204b. When the kernel finishes the core dump process, it can completely terminate the crashed process 204a, but, in at least one embodiment, because an existing regular file descriptor of the crashed process 204a is accessed or opened, such as via pidfd_getfd, in a new instance, the underlying object (e.g., socket) will not be closed because it will have a nonzero reference count.

Referring to the example 400 of FIG. 7, the line 402 includes the following code that can be executed by the new process instance 204b:
int pidfd=syscall (SYS_pidfd_open, 1234/*PID*/, 0);
which i) performs a pidfd_open system call (syscall) to open or access the crashed process instance 204a having the PID 1234, ii) creates a new file descriptor pidfd in the namespace and address space of the new process instance 204b, and iii) associates the new file descriptor pidfd of the new process instance 204b with the crashed process instance 204a. Thus, after executing 402, the integer variable pidfd is a special file descriptor or handle that is associated with the crashed process instance 204a. In this example, the syscall parameters of line 402 include:
a) SYS_pidfd_open identifying the pidfd open system call; and
b) 1234 identifying the PID of the crashed process to be opened, accessed and associated with the new pidfd of the new process instance 204b.

In at least one embodiment, executing code of line 402 can generally establish the pidfd of the new process 204b as a communication channel with the kernel to enable the kernel to generally communicate information about the crashed process 204a to the new process 204b where such information can include the regular file descriptors of the crashed process 204a.

After executing code of line 402, the following code of line 404 can be executed by the new process instance 204b:
int remote_fd=syscall(SYS_pidfd_getfd, pidfd, 14/*FD*/, 0);
   which performs a pidfd_getfd system call (syscall) to allocate a new regular file descriptor, remote_fd, in the calling process instance 204b, where the new regular file descriptor, remote_fd, can be a duplicate of an existing regular file descriptor of the crashed process 204a (where the crashed process 204a is associated with or identified by the pidfd file descriptor). However, remote_fd can be identified using a different number in the local namespace and address space of the calling process.
   In this example, the syscall parameters of 404 include:
a) SYS_pidfd_getfd identifying the pidfd_getfd existing file descriptor system call (which gets a particular existing regular file descriptor of the crashed process 204a associated with pidfd); and
b) 14 identifying the existing regular file descriptor of the crashed process to obtain and duplicate in a new regular file descriptor, remote_fd, of the calling new process instance 204b.

In at least one embodiment, 14 can identify the regular file descriptor of a socket owned by or allocated to the crashed process 204a. In this example, the pidfd or special file descriptor in the namespace and address space of the new process 204b can be associated with the crashed process 204a, where the pidfd can be used by the new process 204b to further access the regular file descriptor 14 of the crashed process, and where the file descriptor 14 is associated with a socket.

Thus in line 404, processing uses the pidfd descriptor to communicate with the kernel in the system call of line 404 to obtain specific information about the crashed process 204a for which a connection was previously opened and associated with the pidfd. In line 404, the specific information desired is the regular file descriptor 14. Executing 404 results in creating a new regular file descriptor (remote_fd) in the name space and address space of the calling new process 402b, where remote_fd is associated with (e.g., points to or identifies) the same underlying object as the regular descriptor 14 of the crashed process 402a. Thus in this example, 14 is the regular file descriptor (of the crashed process 204a) which is associated with the same underlying object or resource, such as a socket, as remote_fd of the new process 204b. As a result of the new process 204b executing line 404, the new process 204b can use its remote_fd to take over, and perform associated processing for, the socket of the crashed process. In this example, a new socket is not created but rather the new process 402b uses and can take over communications to and/or from the existing socket of the crashed process 402a.

After executing code of line 404, the following code of line 406 can be executed by the new process instance 204b to use the remote_fd as a TCP listening socket:
sock=accept(remote_fd)

In at least one embodiment and consistent with other discussion herein, the accept call as in line 406 is

used to by the calling process to accept a connection request from a client. The accept( ) function causes a listening socket, such as the socket 412 identified or referenced using remote_fd, to accept the next incoming connection on its queue of pending connections for the given socket associated with remote_fd, and return a socket descriptor for that connection. Accept( ) waits for incoming connections. When a client connects, accept( ) returns a new socket object or descriptor representing the connection. When a connection is available, the socket created is ready for use to read data from the client process that requested the connection. If the queue has no pending connection requests, accept( ) can block the caller, unless the socket is in nonblocking mode.

Referring to element 410 of FIG. 7, shown is an example illustrating a resulting state after executing the code of 401 in at least one embodiment in accordance with the techniques of the present disclosure.

As illustrated in 410, the crashed process 204a can have an existing regular file descriptor FD1 408a that has a value of 14 and is associated with the socket 412. After executing code of lines 402 and 404, the remote_fd 408b of the new process 204b can i) have a value of 25; and ii) be associated with the socket 412. The socket 412 can have an associated reference count (refcount) 408b that is 2 after executing lines 402 and 404, to denote the two references by file descriptors 408a and 408b to the socket 412. When the core dumping process for the crashed process 204a completes and releases the resources of the crashed process 402a, the kernel can decrement the refcount 208b by 1 to correspond to releasing the socket 412 from the crashed process 402 a. In this case, the socket 412 still has a reference count of 1 to denote that the socket resource 412 is now taken over by the new process 402b.

As noted above, to use the mechanism and processing of 401 of FIG. 7, processing needs i) the PID of the old or crashed process instance 204a; and ii) the set of one or more file descriptors (e.g., such as 14 in line 404) of the crashed process 204a to be opened and accessed by the new process 204b.

Described below are various ways in at least one embodiment in which: i) the PID of the old or crashed process instance 204a can be obtained and ii) the set of one or more file descriptors (e.g., such as 14 in line 404) of the crashed process 204a to be opened and accessed by the new process 204b can be obtained.

What will now be described are various ways in which the PID of the crashed or old process 204a can be obtained in at least one embodiment.

As a first option to obtain the PID of the crashed process 204a, the new process 204b can discover the PID of the crashed process instance 204a using a process-specific mechanism. For example, when the process 204a starts, it can write its PID to a predetermined location, such as a particular file. When the process 204a crashes, the new process instance 204b can read the predetermined location, such as the particular file, to obtain the PID of the crashed process 204a.

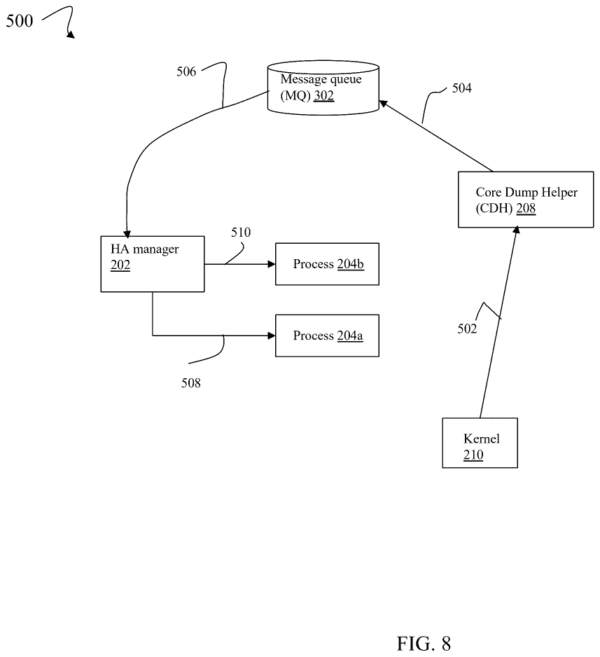

As a second option to obtain the PID of the crashed process 204a, the HA manager can start the new process instance 204b passing the PID of the crashed process 204a as an input parameter. To further illustrate in at least one embodiment with reference to the example 500 of FIG. 8, the PID of the crashed process 204a can be sent (502) from the kernel 210 to the CDH 208. The PID can be included in information, for example, sent from the kernel 210 to the CDH 208 in the step S12Ai of FIG. 5. In response, once the CDH 208 receives the PID of the crashed process instance 204a, the CDH 208 can include the PID of the crashed process in a message sent (504) to the MG 302 in S13 to notify the HA manager 202. The HA manager 202 then obtains or reads (506) the message with the PID from the MG 302, for example, in the step S14 of FIG. 5. When the HA manager 202 performs a normal startup (508) of the process 204a, no PID is passed as an input parameter. In at least one embodiment, when the HA manager 202 starts (e.g., such as in S15 of FIG. 5) the new process instance 204b after a crash of the crashed process instance 402a, the HA manager 202 can also provide (510) the PID of the crashed process instance 204a to the new process instance 204b as an input parameter for its own use and reference, such as in connection with creating the pidfd in line 402. In at least one embodiment using the second option, existing original process code can be modified to include additional modifications, for example, in order to handle receiving and utilizing the PID of the crashed process instance 204 a passed in 510 as an input parameter when starting the new process instance 204 b.

As a third option to obtain the PID of the crashed process 204a, the CDH 208 can save the PID of the crashed process 204a in a predetermined location, such as a file, which is then read by the new process instance 204b. In at least one embodiment of the third option, no special support is needed in the process instances 204a-b or the HA manager. In the third option, the CDH can save the PID of the crashed process 204a in a file. The HA manager can immediately start the new process instance 204b. In at least one embodiment, the new process instance 204b can be started which is unmodified (e.g., same version of code as the crashed process instance 204a) but with an LD_PRELOAD wrapper. When the new process instance 204b performs a specific syscall, code of the wrapper reads the file to obtain the old PID of the crashed process 204a before continuing with processing of the new process 204b. In at least one embodiment, the specific syscall can be the bind syscall. In at least one embodiment of a Linux-based operating system, LD_PRELOAD can be an environment variable included on a command invocation line to start an instance of a process or program. LD_PRELOAD can be a list of one or more shared object libraries (e.g., .SO file extension) that can be loaded at runtime where linker symbol resolution can first search the LD_PRELOAD libraries for a symbol definition, such as a function call, prior to searching other standard libraries that can be subsequently searched in connection with linker symbol resolution. As a result, a library specified using the LD_PRELOAD option or feature can be used to override functions from other subsequently searched libraries in connection with executing the new process or program. In this manner in at least one embodiment, the LD_PRELOAD feature can be used to load a customized modified version of the bind syscall (e.g., bind ( )) whereby all bind syscalls in the invoked process instance resolve to the customized modified version of bind rather than the original real bind syscall code of the standard library. The customized version of bind can then implement the necessary logic and additional processing in the form of a wrapper which conditionally either successfully invokes the real original bind syscall, or otherwise performs necessary processing to obtain, for a crashed process instance, its PID. In at least one embodiment as discussed in more detail elsewhere herein, the wrapper can also perform further processing needed in connection obtaining, for the crashed process instance, its one or more file descriptors each associated with a corresponding resource (such as a socket) to be taken over and handled by the new process instance being invoked.

If the process instance being invoked using the LD_PRELOAD feature is a first or normal instance such as the process 204a (before crashing), the modified version of the bind syscall results in successfully calling the real original bind function and creating a listening socket. If the process instance being invoked using the LD_PRELOAD feature is a new process instance (e.g., 204b) invoked while the kernel is processing the core dump of another crashed process instance (e.g., 204a), the modified version of the bind syscall performs the necessary processing, such as described generally in 712 of FIG. 7 and also in more detail below, to steal or takeover an existing listening socket of the crashed process instance rather than create a new listening socket.

Using the third option in at least one embodiment with the LD_PRELOAD feature can provide a transparent approach in that no changes are needed to the process code to implement the stealing or takeover of resources such as sockets of a crashed process instance. Using the third option, the code of the crashed process 204a and the new process 204b can be identical where the code implementing the stealing or takeover logic can be embodied in the modified version of the bind syscall.

The LD_PRELOAD feature and wrapper and use in at least one embodiment is described in more detail below.

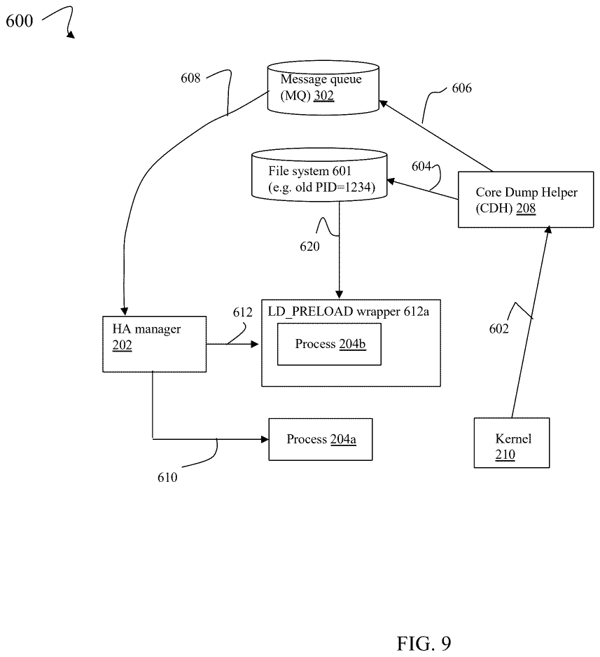

With reference to the example 600 of FIG. 9 with the third option in at least one embodiment, the PID of the crashed process 204a can be sent (602) from the kernel 210 to the CDH 208. The PID can be included in information, for example, sent from the kernel 210 to the CDH 208 in the step S12Ai of FIG. 5. In response, once the CDH 208 receives the PID of the crashed process instance 204a, the CDH 208 can i) write (604) the PID of the crashed process instance 204a to the predetermined location such as a file in the file system 601; and ii) send (606 and as in S13 of FIG. 5)) the PID of the crashed process in a message to the MG 302 in S13 to notify the HA manager 202. The HA manager 202 then obtains or reads (608 and as in S14 of FIG. 5) the message with the PID from the MG 302. The HA manager 202 can perform a normal startup (610) of the process 204a. In at least one embodiment, when the HA manager 202 starts (612 and as in S15 of FIG. 5) the new process instance 204b after a crash of the crashed process instance 402a, wrapper 612a can read (620) the PID of the crashed process 204a from the predetermined file or other location in the file system 601.

What will now be described is how at least one embodiment can determine the set of one or more file descriptors to steal or take over where each such file descriptor corresponds to an associated resource used by crashed process instance, such as process 204a, where the associated resource of the crashed process instance is taken over by the new process instance, such as process 204b. In at least one embodiment, the resources taken over by the new process 204b can include a socket and a corresponding port, such as a network port, where such resources can be allocated to the crashed process 204a, and where such resources can be characterized as stolen, or taken over by the new process 204b. In at least one such embodiment, taking over the foregoing resources of the crashed process 204b can include handling incoming communications from one or more clients over the socket and corresponding port.

In at least one embodiment, a new process instance 204b knows which TCP and/or UDP port numbers it will bind to. Those are the same port numbers used by the previous process instance 204a that crashed. However, the file descriptor numbers used by the old or crashed process instance 204a and the new process instance 204b can differ. As a result, processing can be performed to determine, obtain and/or access the file descriptors of crashed process 204a. In at least one embodiment, one way in which the desired one or more file descriptors of the crashed process 204a can be determined for one or more corresponding port numbers is through use of procfs.

In at least one embodiment, the proc filesystem, or procfs, provides a hierarchical file-like structure for accessing process data in Unix-like operating systems. Procfs is a virtual file system that provides a more convenient and standardized method for dynamically accessing process data held in the kernel than other techniques such as, for example, direct access to kernel memory. In at least one embodiment, procfs can be mapped to a mount point named/roc at boot time. The proc file system or procfs can serve as an interface to internal data structures about running processes in the kernel.

In at least one embodiment, a lookup, search or query can be performed with respect to information stored in procfs in order to determine, for each of the one or more desired ports, a corresponding file descriptor of the crashed process 204a. Procfs has information about every file descriptor of the crashed process 204a. In at least one embodiment, the information from the following procfs paths or directories can be combined to determine which port is associated with which file descriptor within the crashed or old process instance 204a: /proc/net/{tcp, udp} and /roc/<OLDPID>/fdinfo/<FD>, where:
/proc/net is a directory containing useful information about the network stack, such as existing network connections;
OLDPID denotes the PID of the crashed process 204a;
/proc/<OLDPID>/fdinfo is a directory containing information about open file descriptors (e.g., entries which describe the position and flags for each open file descriptor); and
<FD> denotes a particular file descriptor (e.g., number).

More generally, any suitable tool or technique can be used to understand which port is associated with which file descriptor of the crashed or old process instance 204a. For example, in at least one embodiment of a Unix-based system, another tool that can be used to determine which file descriptor of the crashed process instance 204a is associated with a particular TCP port such as port 8080 is the lsof command that lists open

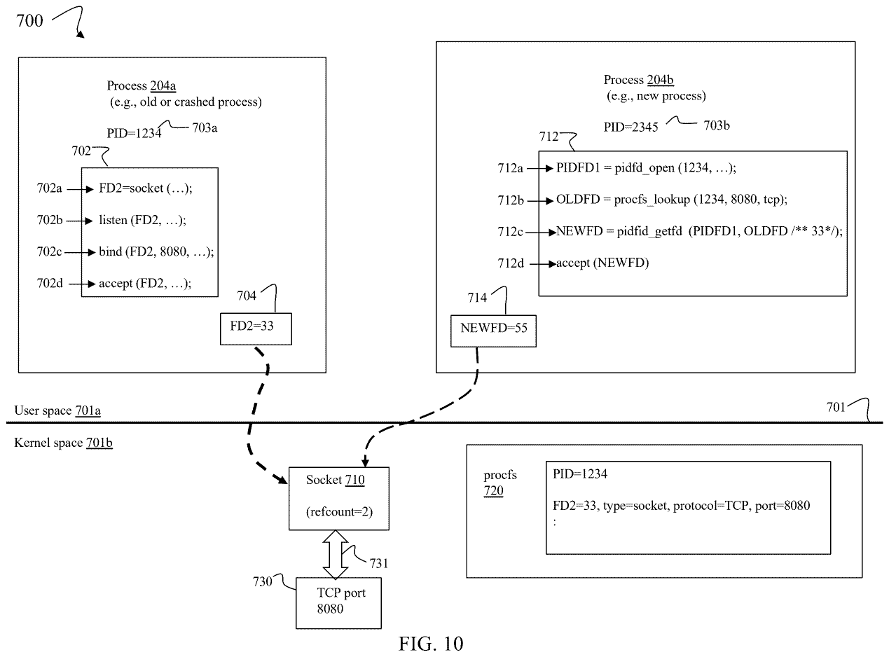

files and the processes that opened them, where such files can include network connections. With reference to FIG. 10, shown is an example 700 illustrating processing performed by the process instances 204a-b in at least one embodiment in accordance with the techniques of the present disclosure. The logic or processing embodied in the new process 204b can be used in connection with determining which particular TCP port of interest, such as port 8080, is associated with particular existing file descriptor of the old or crashed process 204a. Subsequently, the new process 204b can then i) open and access the existing file descriptor of the crashed process 204a, and then ii) create a new file descriptor in the new process 204b where the new file descriptor is associated with the same underlying existing socket and corresponding port of interest. Processing to implement the foregoing in at least one embodiment is described in more detail below with reference to FIG. 10.

In the example 700, all components above the line 701 are in user space and all components below the line 701 are in kernel space 701b. The example 700 includes the processes 204a-b executing in user space 701a. The socket 710 and procfs or the process virtual file system can be in kernel space 701b.

The process 204a can denote the old or original process instance that eventually crashes. The process 204b can denote the new process instance that is started in response to the process 204a crashing. As a result, the old or crashed process 204a can be the process that creates a socket and the new process 204b can be the process that subsequently steals or takes over handling of the socket of the crashed process 204a. As an example, consider a TCP listening socket on port 8080. In a normal case such as when the process 204a originally executes before crashing, the process 204a can use standard system calls (e.g., socket, listen and bind) to create the listening TCP socket. Subsequently, the process 204a can use the accept system call when a new client connects.

In this example, the old or crashed process 204a can have a corresponding PID of 1234 as denoted by 703a. Element 702 includes a sequence of instructions of the process 204a which are executed to create the listening TCP socket 710. Element 704 can denotes the file descriptor FD2 that is associated with the socket 710 where in this example FD2 has a value of 33 in the process 204a. Thus 33 denotes the file descriptor of the old process 204a that subsequently crashes after executing the code of 702. The code of 702 can be characterized as an example of server-side code to setup the process 204a as a server to receive and handle an incoming connection from a client where data can be sent over the connection from the client to the process 204a. In at least one embodiment, the set-up processing performed by the process 204a includes: i) creating a socket (e.g., code of line 702a); ii) having the socket enter a listening state to accept incoming connections (e.g., code of line 702b); iii) associating or binding the socket with a specific network address (e.g., code of line 702c); and iv) using “accept” (e.g., code of line 702d) to retrieve a new socket descriptor for communication with a connected client when a connection request arrives. In at least one embodiment, the code of 702 can be executed sequentially in the order of 702a-d.

In the code of line 702a, “FD2=socket ( . . . );”, the socket call creates the new TCP socket 710, creates a new file descriptor 33 in the old process 204a, and associates the socket 710 with the new file descriptor 33 of the old process 204a. The variable FD2 (704) is assigned the value 33, whereby FD2=33 can be used as a handle that references or is associated with the socket 710.

In the code of line 702b, “listen (FD2, . . . );”, the listen call places the socket 710 in a listening state to accept incoming connections from clients. The listen( ) function sets a flag in the internal socket structure marking the socket as a passive listening socket, on which calls can be accepted. Listen opens the bound port so the socket can then start receiving connections from clients. In the code of line 702c, “bind (FD2, 8080, . . . );”, the bind call binds (731) the listening TCP socket 710 with the TCP port number 8080 (732). Generally, the bind system call attaches a socket to a local address or port, where the socket is associated with the identified file descriptor FD2.

In the code of line 702d, “accept (FD2, . . . );”, the accept( ) call is used by the process 204a to accept a connection request from a client. The accept( ) function causes a listening socket, such as the socket 710 identified or referenced using FD2, to accept the next incoming connection (on its queue of pending connections for the given socket 710 associated with FD2) and return a socket descriptor for that connection. Accept( ) waits for incoming connections. When a client connects, accept( ) returns a new socket object or descriptor representing the connection. When a connection is available, the socket created is ready for use to read data from the client process that requested the connection. If the queue has no pending connection requests, accept( ) can block the caller, the process 204a, unless the socket 710 is in nonblocking mode. Now, assume at a first point in time T1 that the process 204 a executes code of 702 to create the socket 710 associated with the FD2=33 of the process 204a, where the socket 710 is bound to the TC port 8080 (730). Subsequent to T1 at a second point in time T2, the process 204a can crash. Consistent with other discussion herein, the HA manager can start the new process 204b. The new process 204b can have a PID=2345 (703b). In at least one embodiment, the HA manager can pass the PID=1234 of the old crashed process instance 204a to the new process instance 204b, for example, when starting the new process instance 204b. In this case, the new process 204b knows that it needs to perform processing to steal or takeover a TCP listening socket of the crashed process 204a rather than creating a new TCP listening socket (as done by the steps 702a-c). The code of 712 illustrates a sequence of instructions that can be performed by the new process 204b to steal or takeover the TCP listening socket 710 of the crashed process and use the socket 710 to accept a new client connection request from a client and data from the client sent over the connection to the socket 710 using the TC port 8080 (730).

In at least one embodiment, the new process 204b can receive the PID=1234 of the old or crashed process 204a from the HA manager as noted above. Subsequently, the new process 204b can perform the processing of 712 that includes:
i) opening (e.g., by executing code of line 712a) the pidfd descriptor, PIDFD1, using the pidfd_open system call passing the PID=1234 of the old instance;
ii) performing (e.g., by executing code of line 712b) a procfs_lookup call that uses information in procfs 720 to determine that the listening TCP socket 710 on port 8080 corresponds to the file descriptor 33 (FD2 704) of the old crashed process 204a;
iii) opening (e.g., by executing code of line 712c) the old file descriptor FD2=33 of the crashed process 204a and creating a new file descriptor NEWFD=55 (714) corresponding to the old file descriptor 33 (704) of the crashed process 204a; and
iv) passing the new file descriptor of 55 (714) in the accept system call (e.g., by executing code of line 712d) to retrieve a new socket descriptor for communication with a connected client when a connection request arrives. In at least one embodiment, the code of 712 can be executed sequentially in the order of 712a-d.

In the code of line 712a, “PIDFD1=pidfd_open (1234, . . . );”, the pidfd_open system call opens a connection to the crashed process 204a where the PIDFD1 descriptor is associated with the crashed process 204a (as identified by its PID 1234). PIDFD1 can denote a special pidfd file descriptor of the process 204b. The code of line 712a performs processing similar to line 402 of FIG. 7.

In the code of line 712b, “OLDFD=procfs_lookup (1234, 8080, tcp);”, the procfs_lookup call performs a query or look up of information based on the input parameters of: “1234” denoting the PID of the crashed process 204a, “8080” denoting the port of interest, and “tcp” indicating that the port “8080” is a TCP port. In response, procfs_lookup performs processing to return a corresponding regular file descriptor of the process 204a with PID=1234 where the returned corresponding file descriptor of the process 204a is associated with the TCP port 8080. In particular, the corresponding file descriptor can be 33 (704) that is attached or associated with a socket, such as socket 710, that is bound to the TCP port 8080. In line 712b, the returned file descriptor is 33 corresponding to FD2 704 whereby OLDFD is assigned 33.

Consistent with discussion above, an embodiment can use other techniques and processing besides procfs as in 712b to determine the file descriptor of the crashed process 204a that is associated with the TCP port 8080 of interest.

In the code of line 712c, “NEWFD=pidfid_getfd (PIDFD1, OLDFD /**33*/);”, the pidfid_getfd system call performs processing similar to line 404 of FIG. 7. In line 712c, the PIDFD1 parameter identifies the crashed process 204a, and OLDFD=33 identifies the particular file descriptor of the crashed process 204a. Thus in line 712c, processing uses the pidfd descriptor, PIDFD1, to communicate with the kernel in the pidfid_getfd call to obtain specific information about the crashed process 204a for which a connection was previously opened and associated with the PIDFD1. In line 712c, the specific information desired is the regular file descriptor 33. Executing 712c results in creating a new regular file descriptor (NEWFD) in the name space and address space of the calling new process 402b, where NEWFD is associated with (e.g., points to or identifies) the same underlying object as the regular file descriptor 33 of the crashed process 402a. Thus

in this example, 33 is the regular file descriptor (704 of the crashed process 204a) which is associated with the same underlying object or resource (socket 710) as NEWFD 714 of the new process 204b. As a result of the new process 204 b executing line 712 c, the new process 204b can use NEWFD (file descriptor 55 (714) in process 204b) to take over, and perform associated processing for, the socket 710 of the crashed process, where the socket 710 is bound (731) to the TCP port 8080 (732). In this example, a new socket is not created but rather the new process 402b can use NEWFD=55 (714) to take over communications with the existing socket 710 of the crashed process 402a, and thereby takeover communications with the TCP port 732.

In the code of line 712d, “accept (NEWFD);”, the accept call is generally described elsewhere herein. The accept( ) call is used by the process 204b to accept a connection request from a client. The accept( ) function causes a listening socket, such as the socket 710 identified or referenced using NEWFD=55 (714), to accept the next incoming connection (on its queue of pending connections for the given socket 710 associated with NEWFD) and return a socket descriptor for that connection. Accept( ) waits for incoming connections. When a client connects, accept( ) returns a new socket object or descriptor representing the connection. When a connection is available, the socket created is ready for use to read data from the client process that requested the connection. If the queue has no pending connection requests, accept( ) can block the caller, the process 204b, unless the socket 710 is in nonblocking mode.

In connection with the FIG. 10, the code 712 illustrates pseudocode or instructions that embody processing performed to obtain the existing file descriptor 704 of the crashed process 204a to obtain a new corresponding descriptor 714 in the address space of the new process 204b. The descriptors NEWFD 714 and FD2 704 both point to, or reference, the same underlying socket 710. However, since the process 204a has crashed, the process 204a will not read from the socket 710 and will not accept any new connections from clients over socket 710. After completing processing of 712, the new client connections and data can be accepted and read over the socket 710 where the foregoing is performed with respect to the process 204b rather than 204a. Thus with the embodiment of FIGS. 10, 712 provides for the new process 204 b taking over and handling client communications associated with the socket 710 and TCP port 730. Put another way after executing code of 712, all subsequent client connection requests to socket 710 and all corresponding client data read or sent to the socket 710 is handled only by the new process 204b whereby only new process 204b will read from, or listen on, the socket 710.

It should be noted that the reference count of 2 of the socket 710 can denote the number of references (e.g., from file descriptors 704 and 714) to the socket 710, after executing code of 710 and 712, and prior to the kernel completing the core dump and fully terminating the crashed process 204a. Once the kernel complete the core dump and fully terminates the crashed process 204a, the reference count can be decremented by 1 as a result of the kernel releasing the resources (e.g., file descriptor 204) of the process 204a. In this example, the resources released can include the file descriptor 204 thereby removing one reference or pointer to the socket 710. Thus after the resources of the process 204 are released, the reference count of the socket 710 are 1.

It should be noted that line 712a of 712 (e.g., FIGS. 10) and 402 of 401 (e.g., FIG. 7) can denote equivalent ways of performing the same system call or sys call with different calling interfaces. In a similar manner, line 712c of 712 and 404 of 401 can denote equivalent ways of performing the same system call or sys call with different calling interfaces. In the code 401 of FIG. 7, the old existing file descriptor of the old crashed process 204a is 14 and explicitly included as an input parameter in the call of 404 . In contrast with reference to FIG. 10, the old existing file descriptor, OLDFD=33, of the crashed process 204a in FIG. 10 can be looked up or determined using the code of line 712b.

The above approach as illustrated in connection with FIG. 10 can be performed by making minimal changes to code of the process related to the creation or taking over of network sockets. Put another way in at least one embodiment, the code of the process can be modified to embody the logic of 702 and 712 where 702 is conditionally performed for the normal case or processing mode, and where 712 is conditionally performed for the alternative case or processing mode to start the new process instance that steals or takes over resources (e.g., an existing file descriptor, existing corresponding socket and corresponding port) of the crashed process instance 204a. In at least one embodiment, the processing of FIG. 10 can be performed in connection with an HA manager that operates as in the second option (e.g., as in FIG. 8) where the HA manager starts the process in either i) the normal mode (508) thereby starting the process instance 204a without passing any PID as an input, or ii) the alternative mode (510) where the HA manager passes the PID of the old crashed process instance 204a as an input parameter when invoking or starting the process. When the HA manager invokes the process passing the PID of the old crashed instance 204a (e.g., such as in 510 of FIG. 8), code of the process can recognize or determine that the processing of 712 should be performed rather than 702. When the HA manager invokes the process without passing any such PID (e.g., such as in 508 of FIG. 8), code of the process can recognize or determine that the processing of 702 should be performed rather than 712. In one aspect, an embodiment of the second option (such as described in connection with FIGS. 8 and 10) can be characterized as non-transparent whereby the process can be modified to accommodate any needed code changes. In this particular embodiment, the original process code can be modified to embody the conditional processing and logic of both 702 and 712 based, at least in part, on whether the HA manager invokes the process with an input argument (e.g., PID of old crashed process) or not.

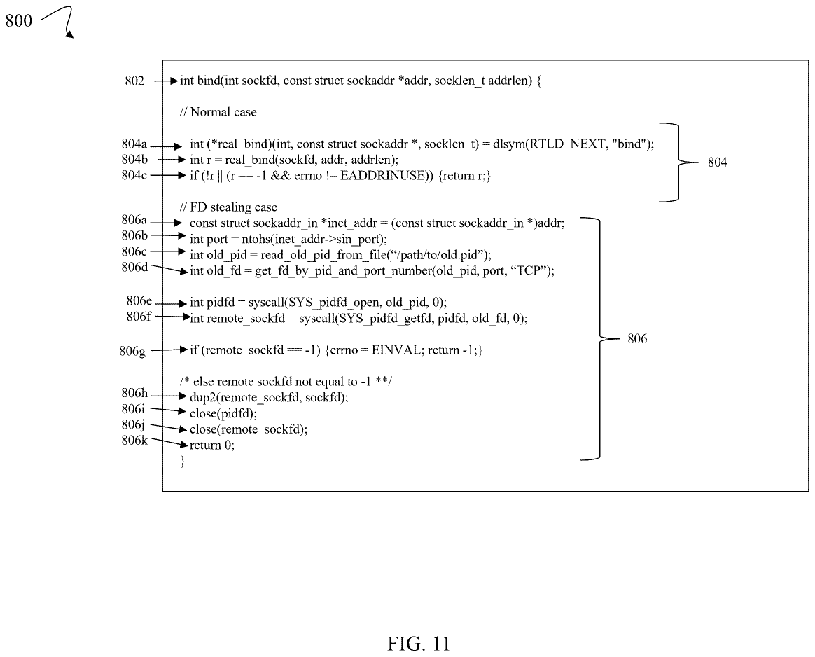

However, it is also possible to make this approach fully transparent to the process itself. Put another way in at least one embodiment, the techniques of the present disclosure can be implemented in a manner characterized as transparent with respect to the process itself without modifying the code of the original process as in connection with the second option with FIG. 10. In connection with the transparent embodiment generally described above in connection with FIG. 9 and described further below in connection with FIG. 11, code changes needed can be embodied in a wrapper outside of the process without modifying the original process code to implement the techniques of the present disclosure. Additionally in at least one such embodiment, the unmodified process can be started by the HA manager using the same command line discussed below using the LD_PRELOAD feature where the wrapper handles all needed processing for conditionally either performing normal mode processing or alternatively performing processing for the alternative mode where the new process instance steals and takes over communications of an existing file descriptor, a corresponding existing socket and corresponding port associated with the crashed process instance.

To achieve this in at least one embodiment, the bind system call can be intercepted or overridden using the LD_PRELOAD feature or mechanism noted above (e.g., in connection with FIG. 9) and described in more detail below with reference to the example 800 of FIG. 11. The example 800 illustrates instructions or pseudo code embodying logic of the wrapper that can be performed in connection with a customized modified version of the bind function in at least one embodiment in connection with the third option such as discussed herein in connection with FIG. 9.

Consistent with the third option such as discussed above in connection with FIG. 9, the HA manager can start the new process 204b using the LD_PRELOAD feature. For example, the code of the modified version of the bind function can be included in the file or library “=/bin/bind_interceptor.so”. In this example, the process can be located at “bin/app”. In this example, the same process code located at “bin/app” can be used in connection with previously starting the old process instance 204a and also now starting the new process instance 204b after 204a crashes. The command to run or execute the process, when starting both the instance 204a that crashes and when starting the new process instance 204b in response to 204a crashing, can be specified as “LD_PRELOAD /in/bind_interceptor.so/in/app” rather than just “/bin/app”. The LD_PRELOAD added file or library “bind_interceptor.so” can include code for the customized or modified bind function that can override the existing or real bind function code included in another standard library.

In at least one embodiment, the LD_PRELOAD feature or option is one that can be used in connection with intercepting or overriding an existing function, such as the bind function, with another customized implementation of the same function. The customized implementation of the function can generally be included in a wrapper separate from the process code of “bin/app”. In this manner the process can transparently invoke the function without modification whereby at runtime, the actual body of code executed for the function is that of the customized implementation in the wrapper file or library (e.g., bind_interceptor.so) specified using the LD_PRELOAD feature. In at least one embodiment, starting the process as “LD_PRELOAD=/bin/bind_interceptor.so/in/app” rather than just “/bin/app” can also be referred to as a transparent mode of execution for starting an instance of the process.

With the foregoing command, “LD_PRELOAD=/bin/bind_interceptor.so/in/app”, to run the process instances 204a and b, linker symbol resolution processing can first look to the added file or library “bind_interceptor.so” identified with the LD_PRELOAD feature to resolve the bind function reference to the modified or customized version of “bind_interceptor.so” rather the real bind function of a standard library. In this manner, when an instance of the process calls the bind system call, it is intercepted and control is transferred to the modified or customized version of the bind function rather the real bind function. Processing in the form of pseudocode that can be performed by the modified or customized version of the bind function in at least one embodiment is illustrated in the example 800 of FIG. 11 discussed below. In the example 800 of FIG. 11, processing of the modified or customized version of the bind function can first try to call (e.g., in 804b) real bind, the real implementation of the bind system call. If the call to real bind succeeds or fails with any other error besides EADDRINUSE, then processing can return (e.g., as in 804c) to the calling application or process. This (e.g., whereby the if condition of line 804c evaluates to true), happens in a normal case or execution mode or when the core dump is disabled or completes very quickly. If the real bind system call fails with EADDRINUSE error code (e.g., whereby the if condition of line 804c evaluates to false), then it can be concluded that the kernel is still processing a core dump of the old or crashed process 204a. In this latter case, processing continues with i) reading (e.g., 806c) the old PID of the crashed process 204a from the file where previously stored by CDH, and ii) opening (e.g., 806e) the pidfd descriptor for old process. Processing can perform a procfs or other lookup (e.g., 806d) for i) the port passed as an input argument to bind system call and ii) the old PID, to determine the file descriptor corresponding to that port in the old crashed process 204a. Once determined, processing can obtain (e.g., 806f) the corresponding file descriptor from the old crashed process 204a as remote_sockfd. A dup2 system call can be performed (e.g., 806h) so that this remote file descriptor is duplicated to the file descriptor the caller passed to bind system call. Finally, processing can close both pidfd (e.g., 806i) and remote_sockfd (e.g., 806k) and return (e.g., 806l). In at least one embodiment, the EADDRINUSE error can be returned indicating that the port number the bind call 804b is trying to bind to is already being used by another process or application which is assumed to be the crashed process instance 204a in this example.

The line 802, “int bind(int sockfd, const struct sockaddr*addr, socklen_t addrlen)”, specifies the function call interface for the modified or customized version of the bind function that overrides or replaces the code of the original or real bind function of another standard library. In line 802:
sockfd: is an input parameters that is the file descriptor of the socket to bind, where socketfd is obtained from a prior socket( ) system call.
addr: is a pointer to a sockaddr structure that contains the address or port number to bind to. The structure's format depends on the address family used when creating the socket.
addrlen: is the size of the sockaddr structure in bytes.

The code portion 804 denotes processing that can be performed to handle the normal case or normal processing such as, for example, when the original or old process 204a executes rather than the new process 204b in response to old process 204a crashing.

In code of line 804a, “int (*real_bind)(int, const struct sockaddr*, socklen_t)=dlsym(RTLD_NEXT, “bind”);” processing is performed to obtain the address of the real bind function of the standard library. In this example, dlsym can be an existing function used to obtain the address of the real bind function which has been overridden or intercepted by our customized implementation of 800 using the LD_PRELOAD feature. In code of line 804b, “int r=real_bind(sockfd, addr, addrlen);”, the call is made to the real or original bind function.

In code of line 804c, “if (!r∥(r==−1 && errno !=EADDRINUSE)) {return r;}”, a determination is made as to whether i) the call to the real bind function in 804b succeeded or failed with an error code other than EADDRINUSE, or otherwise ii) failed with the EADDRINUSE error code. If the real bind call of 804b succeeds or fails with an error code other than EADDRINUSE, the control is returned to the calling process or program code. The real bind call of 804b can succeed, for example, in the normal case as noted above. In at least one embodiment, the real bind call of 804b can also succeed, for example, if core dump processing is disabled or if the core dump of the crashed process 804a completes prior to starting the new process 204b If the real bind call fails with the EADDRINUSE error code, it can be determined that the kernel is still

processing the core dump of the old crashed process 204a whereby processing continues with line 806a. The EADDRINUSE error code is an “address already in use” error which indicates that the port number the call of line 804b is trying to bind to is already being used by another process or application (e.g., the call 804b is trying to use a port that is already in use by another process, which in this case is the crashed process instance 204a).

The code portion 806 denotes processing that can be performed to handle the stealing or takeover case processing of the existing socket 710 and corresponding port 730 such as, for example, when the new process 204b starts execution in response to old process 204a crashing but the core dump processing for the crashed process 204a is in progress. The code of lines 806a-b obtains the port number to be bound and assigns it to the variable port. For example, the port can be 8080 denoting the TCP port number to be bound. Generally, the bind call input argument addr noted above can point to a structure that includes the desired TCP port number such as 8080 to bound.

In code of line 806c, “int old_pid=read_old_pid_from_file(“/path/to/old.pid”);”, processing is performed to read the old_pid, the PID of the crashed or old process 204a, from the predetermined location (e.g., file) as stored, for example, by the CDH.

In code of line 806d, “int old_fd=get_fd_by_pid_and_port_number(old_pid, port, “TCP”);” processing is performed to obtain the old_fd denoting the file descriptor of the crashed or old process 204a (e.g., as identified by the old_PID), where the old_fd is bound or associated with the desired TCP port 8080 (e.g., where the desired port is identified by the “port” and “TCP” parameters, where port=8080). In at least one embodiment, the call to get_fd_by_pid_and_port_number can result in performing a procfs lookup (e.g., as in 712b) or using other tools or techniques to determine the old_fd.

In code of line 806e, “int pidfd=syscall(SYS_pidfd_open, old_pid, 0);”, the pidfd_open system call opens a connection to the old or crashed process 204a (identified by the old_pid) where the pidfd descriptor is associated with the crashed process 204a. The code of line 806e is similar to, for example, 402 of FIGS. 7 and 712a of FIG. 10.

In code of line 806f, “int remote_sockfd=syscall(SYS_pidfd_getfd, pidfd, old_fd, 0);”, the pidfd_getfd system call obtains the file descriptor and creates a new file descriptor, remote_sockfd, in the calling process (e.g., new process 204b), where remote_sockfd is associated with or points to the same underlying object (e.g., socket) as the old_fd of the crashed process 204a. The code of 806f is similar to, for example, 404 of FIG. 7 and 712c of FIG. 10.

In code of line 806g, “if (remote_sockfd==−1) {errno=EINVAL; return −1;}”, error handling is specified in case the call of 806f returns an error.

In code of line 806h, “dup2(remote_sockfd, sockfd);”, the dup2 system call duplicates the remote_sockfd to the file descriptor, sockfd, the caller passed in the bind system call 802 while using the file descriptor number or index of the input parameter sockfd. In 806h, the dup2 call results in assigning the sockfd file descriptor to point to the same underlying object, the existing socket, as the remote_sockfd file descriptor but where sockfd can retain its original file descriptor number or index rather than be assigned the new descriptor number or index of remote_sockfd. In this manner for the stealing or takeover case, control can be returned to the calling process or program code where the sockfd parameter of the original bind call references the same underlying object or socket which is associated with remote_sockfd. In at least one embodiment for transparency using dup2, the sockfd descriptor can retain its original file descriptor number or index (as passed into the bind call) although the underlying object or socket it references is the existing socket of the crashed process instance. Put another way, logic embodied in the code of 800 either i) returns the results of calling the real bind function (e.g., lines 804b-c) that binds the sockfd input parameter to the specified port number identified by the addr input parameter for the normal case, or ii) perform processing for the stealing or takeover case where the new process instance (calling process) takes over the existing socket and port corresponding to the old existing file descriptor of the crashed process instance. In the latter case, the sockfd input parameter is modified by the dup2 call (806h) to reference the existing socket also referenced by the remote_sockfd file descriptor. To further illustrate, assume that the bind call of the new process 402b provides a sockfd file descriptor input parameter using file descriptor index or number 55. The bind call results in calling the modified version of the bind function as in FIG. 11. In performing the processing of 800 for the bind call from the new process instance 204b, line 806f can result in allocating and assigning a new file descriptor index or number 56 of the new process instance to remote_sockfd, where remote_sockfd is associated with the existing socket of the crashed process 204a. The calling process knows about and is using sockfd having the existing file descriptor index or number 55.

For transparency to the calling process instance 204b, processing of 806h (dup2 call) can update sockfd to reference the existing underlying object, the socket, also associated with or referenced by the remote_sockfd file descriptor. Additionally for transparency the dup2 call of 806h can preserve or retain the existing file descriptor index or number 55 of sockfd while also modifying sockfd to reference or point to the socket of the crashed process 204a. In this manner, the new process 204b can continue to use its existing file descriptor index 55 now associated with the existing socket of the crashed process 204a.

In code of line 807i, “close(pidfd);”, the close system call closes the pidfd.

In code of line 807j, “close(remote_sockfd);”, the close system call closes the remote_sockfd.

In code of line 807k, “return 0;”, 0 is returned.

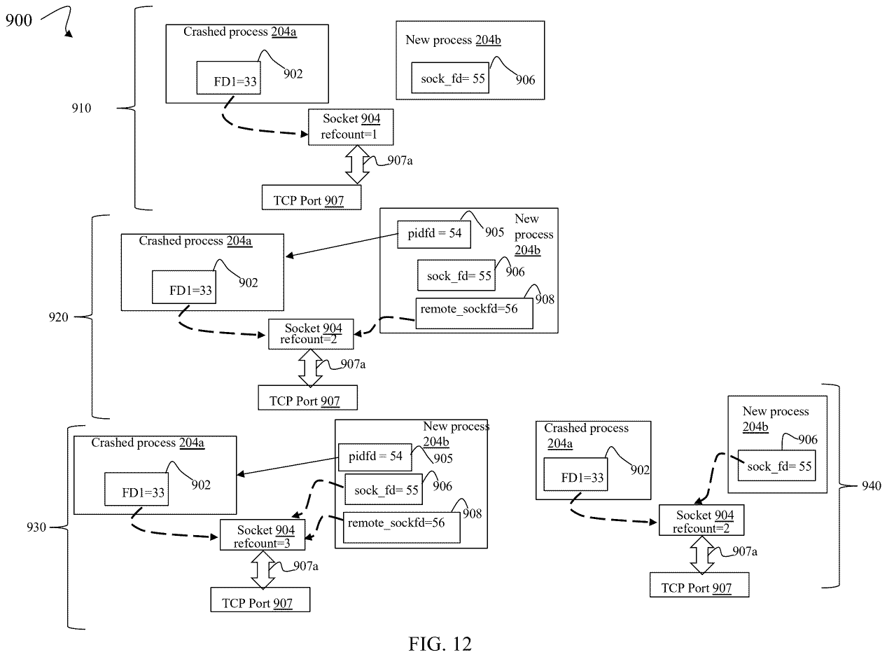

In at least one embodiment with the third option which is transparent and the process code is unmodified, the process code can be as illustrated in 204a. In this case, the bind system call at line 702c results in calling the customized or modified version of the bind function as described in FIG. 11. The modified version of the bind function as in FIG. 11 can embody processing and logic to conditionally perform i) normal mode or case processing where the real bind system call results are returned to the calling program (e.g., line 804c if condition evaluating to true); or ii) stealing or takeover case processing (e.g., beginning at line 806a). Execution of the code of 800 is further illustrated with reference now to the example 900 of FIG. 12. Elements 910, 920 and 930 can denote states of the processes 204a-b at 3 different points in time.

At a first point in time T21 as represented by element 410, assume that the original process instance 204a has executed code, such as 702, that results in creating file descriptor FD1 33 (902) that is associated with the existing socket 904, where the socket 904 is bound (907a) to the TCP port 907. Also at T21, assume the process instance 204a has crashed, and the HA manager has started a new process instance 204b where the new process instance 204b has created an existing file descriptor sock_fd (906) with the file descriptor index 55. The file descriptor 906 can be created, for example, as a result of the new process instance 204b executing socket and listen calls. At time T21, the element 410 can denote the state of the new process instance 204b just

prior to the performing a bind call that is intercepted resulting in transfer of control to the modified bind function code of FIG. 11. At time T21, the socket 904 has a reference count of 1 due to the association of the file descriptor FD1 33 (902) with the socket 904.

At time T22 subsequent to T21, the new process instance 204b can perform the bind call that results in transfer of control to the code of FIG. 11 to execute code of 800. In this example, processing of 800 results in the real bind call (804b) failing with the EADDRINUSE error code since the kernel is still performing core dump processing for the crashed process instance 204a. As a result, control proceeds to execute 806a-f. As a result of 806e, the pidfd file descriptor 54 (905) is allocated and associated with, or references, the crashed process 204a. As a result of 806f, the remote_sockfd file descriptor 56 (908) is allocated and associated with, or references, the underlying socket 904 also referenced or associated with the file descriptor FD1 33 (902) of the crashed process 204a. Thus element 920 can denote the state after the new process 204b completes execution of 806f. At time T22, the socket 904 has a reference count of 2 due to i) the association of the file descriptor FD1 33 (902) with the socket 904, and ii) the association of the file descriptor remote_sockfd 56 (908) with the socket 904.

At time T23 subsequent to T22, the new process instance 204b can execute 806h resulting in the state as illustrated by 930. As a result of executing 806h, the sock_fd descriptor 55 (906) is modified to reference or be associated with the socket 904 while retaining its corresponding file descriptor index or number of 55.

At time T23, the socket 904 has a reference count of 3 due to i) the association of the file descriptor FD1 33 (902) with the socket 904, ii) the association of the file descriptor remote_sockfd 56 (908) with the socket 904, and iii) the association of the file descriptor sockfd 55(906) with the socket 904.

At time T24 subsequent to T23, the new process 204b can execute 806i and 806j that respectively release and delete the descriptors 905 and 908. Once the descriptor remote_sockfd 55 (906) is closed in 906j, the reference count of the socket 904 can be decremented by 1 to 2 to denote the removal of the reference by the file descriptor remote_sockfd 56 (908) to the socket 904. The foregoing state at time T24 is denoted by element 940.

The techniques of the present disclosure provide for eliminating the dependency on the completion of a potentially long core dump handling process and allows the HA manager to immediately start a new instance of a crashed process, such as a critical process, thereby reducing the downtime of, and increasing the availability of, the critical process.

The techniques of the present disclosure can be used in connection with a wide range of use cases and scenarios where the system or server has sufficient memory to accommodate running the second new process instance 204b while the core dump processing of the crashed process instance 204a is in progress. In at least one embodiment, the techniques of the present disclosure can be implemented completely transparently to the processes 204a-b, such as illustrated in connection with the third option and the particular embodiment described in connection with FIG. 11.

In at least one embodiment, the techniques of the present disclosure provide a novel approach to reducing the downtime of a critical process that crashes by eliminating the dependency of core dump completion from a HA processing flow including the HA manager. In at least one embodiment, the techniques of the present disclosure provide for the foregoing via sharing of a network socket between the old crashed instance 204a and the new instance 204b of the critical process.

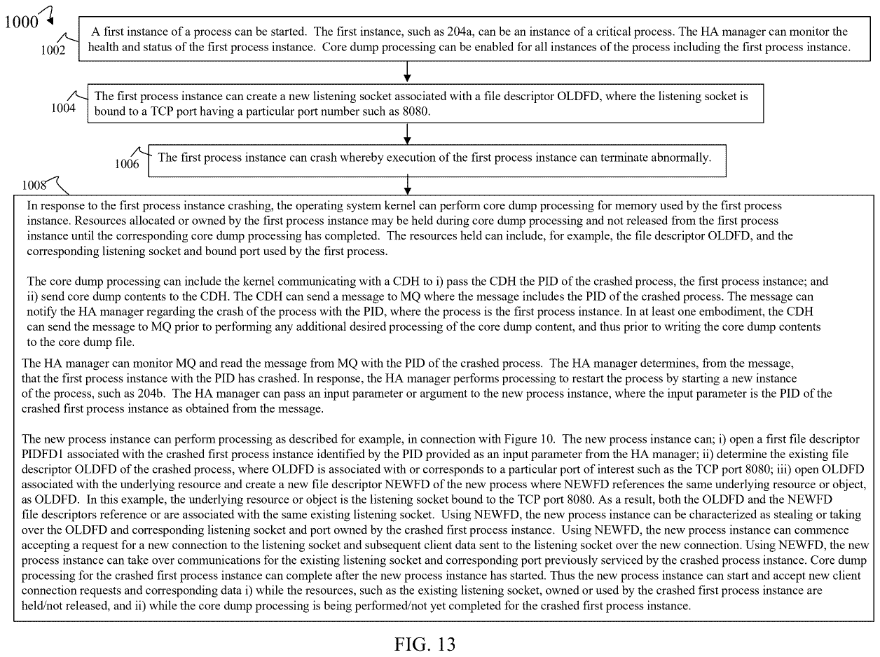

Referring to FIG. 13, shown is a flowchart 1000 of processing steps that can be performed in at least one embodiment in accordance with the techniques of the present disclosure in accordance with the second option described above such as, for example, in connection with FIGS. 8 and 10.

At the step 1002, a first instance of a process can be started. The first instance, such as 204a, can be an instance of a critical process. The HA manager can monitor the health and status of the first process instance. Core dump processing can be enabled for all instances of the process including the first process instance. From the step 1002, control proceeds to the step 1004.

At the step 1004, the first process instance can create a new listening socket associated with a file descriptor OLDFD, where the listening socket is bound to a TCP port having a particular port number such as 8080. From the step 1004, control proceeds to the step 1006.

At the step 1006, the first process instance can crash whereby execution of the first process instance can terminate abnormally. From the step 1006, control proceeds to the step 1008.

At the step 1008, in response to the first process instance crashing, the operating system kernel can perform core dump processing for memory used by the first process instance. Resources allocated or owned by the first process instance may be held during core dump processing and not released from the first process instance until the corresponding core dump processing has completed. The resources held can include, for example, the file descriptor OLDFD, and the corresponding listening socket and bound port used by the first process.

In the step 1008, the core dump processing can include the kernel communicating with a CDH to i) pass the CDH the PID of the crashed process, the first process instance; and ii) send core dump contents to the CDH. The CDH can send a message to MQ where the message includes the PID of the crashed process. The message can notify the HA manager regarding the crash of the process with the PID, where the process is the first process instance. In at least one embodiment, the CDH can send the message to MQ prior to performing any additional desired processing of the core dump content, and thus prior to writing the core dump contents to the core dump file.

In the step 1008, the new process instance can perform processing as described for example, in connection with FIG. 10. The new process instance can; i) open a first file descriptor PIDFD1 associated with the crashed first process instance identified by the PID provided as an input parameter from the HA manager; ii) determine the existing file descriptor OLDFD of the crashed process, where OLDFD is associated with or corresponds to a particular port of interest such as the TCP port 8080; iii) open OLDFD associated with the underlying resource and create a new file descriptor NEWFD of the new process where NEWFD references the same underlying resource or object, as OLDFD. In this example, the underlying resource or object is the listening socket bound to the TCP port 8080. As a result, both the OLDFD and the NEWFD file descriptors reference or are associated with the same existing listening socket. Using NEWFD, the new process instance can be characterized as stealing or taking over the OLDFD and corresponding listening socket and port owned by the crashed first process instance. Using NEWFD, the new process instance can commence accepting a request for a new connection to the listening socket and subsequent client data sent to the listening socket over the new connection. Using NEWFD, the new process instance can take over communications for the existing listening socket and corresponding port previously serviced by the crashed process instance. Core dump processing for the crashed first process instance can complete after the new process instance has started. Thus the new process instance can start and accept new client connection requests and corresponding data i) while the resources, such as the existing listening socket, owned or used by the crashed first process instance are held/not released, and ii) while the core dump processing is being performed/not yet completed for the crashed first process instance.

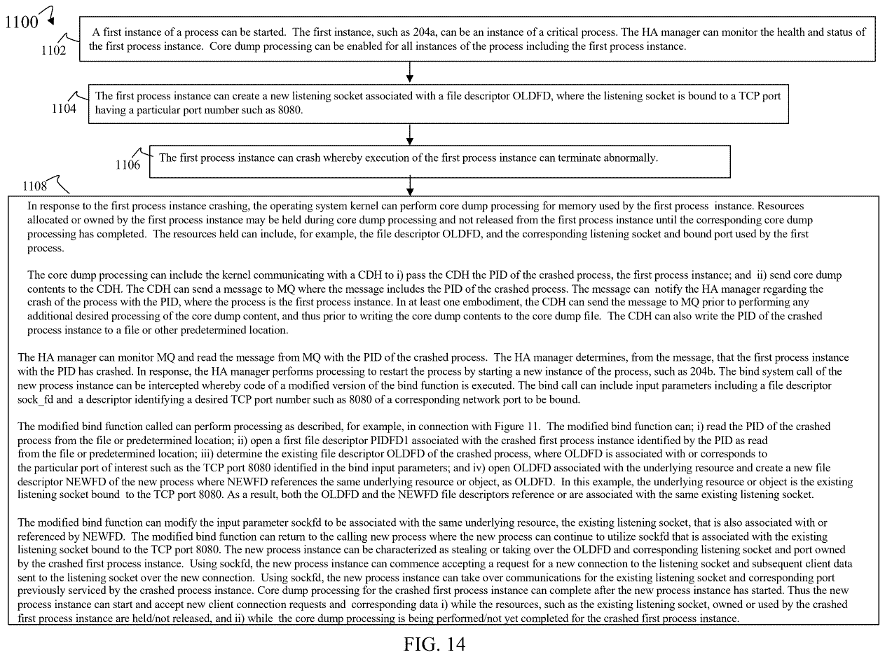

Referring to FIG. 14, shown is a flowchart 1100 of processing steps that can be performed in at least one embodiment in accordance with the techniques of the present disclosure in accordance with the third option described above such as, for example, in connection with FIGS. 9 and 11.

At the step 1102, a first instance of a process can be started. The first instance, such as 204a, can be an instance of a critical process. The HA manager can monitor the health and status of the first process instance. Core dump processing can be enabled for all instances of the process including the first process instance. From the step 1102, control proceeds to the step 1104.

At the step 1104, the first process instance can create a new listening socket associated with a file descriptor OLDFD, where the listening socket is bound to a TCP port having a particular port number such as 8080. From the step 1004, control proceeds to the step 1106.

At the step 1106, the first process instance can crash whereby execution of the first process instance can terminate abnormally. From the step 1106, control proceeds to the step 1108.

At the step 1108, in response to the first process instance crashing, the operating system kernel can perform core dump processing for memory used by the first process instance. Resources allocated or owned by the first process instance may be held during core dump processing and not released from the first process instance until the corresponding core dump processing has completed. The resources held can include, for example, the file descriptor OLDFD, and the corresponding listening socket and bound port used by the first process.

In the step 1108, the core dump processing can include the kernel communicating with a CDH to i) pass the CDH the PID of the crashed process, the first process instance; and ii) send core dump contents to the CDH. The CDH can send a message to MQ where the message includes the PID of the crashed process. The message can notify the HA manager regarding the crash of the process with the PID, where the process is the first process instance. In at least one embodiment, the CDH can send the message to MQ prior to performing any additional desired processing of the core dump content, and thus prior to writing the core dump contents to the core dump file. The CDH can also write the PID of the crashed process instance to a file or other predetermined location.

In the step 1108, the HA manager can monitor MQ and read the message from MQ with the PID of the crashed process. The HA manager determines, from the message, that the first process instance with the PID has crashed. In response, the HA manager performs processing to restart the process by starting a new instance of the process, such as 204b. The bind system call of the new process instance can be intercepted whereby code of a modified version of the bind function is executed. The bind call can include input parameters including a file descriptor sock_fd and a descriptor identifying a desired TCP port number such as 8080 of a corresponding network port to be bound.

In the step 1108, the modified bind function called can perform processing as described, for example, in connection with FIG. 11. The modified bind function can; i) read the PID of the crashed process from the file or predetermined location; ii) open a first file descriptor PIDFD1 associated with the crashed first process instance identified by the PID as read from the file or predetermined location; iii) determine the existing file descriptor OLDFD of the crashed process, where OLDFD is associated with or corresponds to the particular port of interest such as the TCP port 8080 identified in the bind input parameters; and iv) open OLDFD

associated with the underlying resource and create a new file descriptor NEWFD of the new process where NEWFD references the same underlying resource or object, as OLDFD. In this example, the underlying resource or object is the existing listening socket bound to the TCP port 8080. As a result, both the OLDFD and the NEWFD file descriptors reference or are associated with the same existing listening socket.

In the step 1108, the modified bind function can modify the input parameter sockfd to be associated with the same underlying resource, the existing listening socket, that is also associated with or referenced by NEWFD. The modified bind function can return to the calling new process where the new process can continue to utilize sockfd that is associated with the existing listening socket bound to the TCP port 8080. The new process instance can be characterized as stealing or taking over the OLDFD and corresponding listening socket and port owned by the crashed first process instance. Using sockfd, the new process instance can commence accepting a request for a new connection to the listening socket and subsequent client data sent to the listening socket over the new connection. Using sockfd, the new process instance can take over communications for the existing listening socket and corresponding port previously serviced by the crashed process instance. Core dump processing for the crashed first process instance can complete after the new process instance has started. Thus the new process instance can start and accept new client connection requests and corresponding data i) while the resources, such as the existing listening socket, owned or used by the crashed first process instance are held/not released, and ii) while the core dump processing is being performed/not yet completed for the crashed first process instance.

The techniques herein can be performed by any suitable hardware and/or software. For example, techniques herein can be performed by executing code which is stored on any one or more different forms of computer-readable media, where the code can be executed by one or more processors, for example, such as processors of a computer or other system, an ASIC (application specific integrated circuit), and the like. Computer-readable media can include different forms of volatile (e.g., RAM) and non-volatile (e.g., ROM, flash memory, magnetic or optical disks, or tape) storage which can be removable or non-removable.

While the techniques of the present disclosure have been presented in connection with embodiments shown and described in detail herein, their modifications and improvements thereon will become readily apparent to those skilled in the art. Accordingly, the spirit and scope of the techniques of the present disclosure should be limited only by the following claims.

What is claimed is:

1. A computer-implemented process comprising:
executing a first process that performs first processing including:
creating a first socket associated with a first file descriptor of the first process; and
binding the first socket, that is referenced using the first file descriptor, to a port having a port number;
the first process crashing including abnormally terminating execution of the first process; and
in response to the first process crashing, performing second processing including:
performing core dump processing of first memory used by the first process; and
starting execution of a second process prior to completing the core dump processing for the first process, wherein the second process performs third processing including:
creating a second file descriptor of the second process, wherein the second file descriptor is associated with the first socket that is i) referenced using the first file descriptor, and ii) bound to the port; and
the second process taking over communications to the port using the second file descriptor and the first socket.

2. The computer-implemented method of claim 1, wherein first resources of the first process are held and not released until the core dump processing for the first process has completed, and wherein the first resources include the first socket and the first file descriptor.

3. The computer-implemented method of claim 1, wherein said first process crashing is performed after the first process completes the first processing.

4. The computer-implemented method of claim 1, wherein the first process is a first instance of a critical process and the second process is a second instance of the critical process.

5. The computer-implemented method of claim 1, wherein the second processing includes:
sending a first process identifier (PID) of the first process after crashing to a core dump helper (CDH).

6. The computer-implemented method of claim 5, wherein the first PID is sent from a kernel of an operating system to the CDH and the second processing includes:
the CDH sending a message to a high availability (HA) manager, wherein the message includes the first PID of the first process that crashed.

7. The computer-implemented method of claim 6, wherein the second processing includes:
the HA manager starting said execution of the second process including passing the first PID as a parameter to the second process.

8. The computer-implemented method of claim 7, wherein the third processing performed by the second process includes:
opening, using the first PID passed as the parameter from the HA manager when starting said execution of the second process, a third file descriptor associated with the first process that has crashed;
determining that the first file descriptor of the first process is associated with the port having the port number;
opening the first file descriptor that is associated with the third file descriptor of the first process that crashed; and
performing said creating the second file descriptor of the second process, wherein the second file descriptor is associated with the first socket as referenced using the first file descriptor.

9. The computer implemented method of claim 8, wherein the third processing performed by the second process includes:
the second process accepting a connection request from a client for the first socket associated with the port; and
the second process accepting first content sent from the client to the port associated with the first socket.

10. The computer-implemented method of claim 9, wherein said determining that the first file descriptor of the first process is associated with the port having the port number includes:
issuing a first query that determines the first file descriptor based, at least in part, on the first PID, the port number, and a network type.

11. The computer-implemented method of claim 10, wherein the network type is any of: TCP (Transmission Control Protocol), and UDP (User Datagram Protocol).

12. The computer-implemented method of claim 6, wherein the second processing includes:
the HA manager starting said execution of the second process; and
the CDH storing the first PID in a file or predetermined location.

13. The computer-implemented method of claim 12, wherein the third processing performed by the second process includes:
the second process issuing a bind function call that is intercepted and transfers control to a customized version of the bind function, wherein the bind function call includes first parameters comprising:
the second file descriptor of the second process and the port number of the port to be bound.

14. The computer-implemented method of claim 13, wherein the customized version of the bind function performs processing including:
reading the first PID from the file or predetermined location;
opening, using the first PID obtained with said reading, a third file descriptor associated with the first process that has crashed;
determining that the first file descriptor of the first process is associated with the port having the port number;
opening the first file descriptor that is associated with the third file descriptor of the first process that crashed;
creating a fourth file descriptor of the second process, wherein the fourth file descriptor references the first socket associated with the first file descriptor; and
updating the second file descriptor, including associating the second file descriptor with the first socket as referenced using the fourth file descriptor.

15. The computer implemented method of claim 14, wherein the third processing performed by the second process includes:
the second process accepting a connection request from a client for the first socket associated with the port; and
the second process accepting first content sent from the client to the port associated with the first socket.

16. The computer-implemented method of claim 1, wherein the first socket is a listening socket.

17. The computer-implemented method of claim 1, wherein the method is performed in a storage system.

18. A system comprising:
one or more processors; and
one or more memories comprising code stored thereon that, when executed, performs a method comprising:
executing a first process that performs first processing including:
creating a first socket associated with a first file descriptor of the first process; and
binding the first socket, that is referenced using the first file descriptor, to a port having a port number;
the first process crashing including abnormally terminating execution of the first process; and
in response to the first process crashing, performing second processing including:
performing core dump processing of first memory used by the first process; and
starting execution of a second process prior to completing the core dump processing for the first process, wherein the second process performs third processing including:
creating a second file descriptor of the second process, wherein the second file descriptor is associated with the first socket that is i) referenced using the first file descriptor, and ii) bound to the port; and
the second process taking over communications to the port using the second file descriptor and the first socket.

19. One or more non-transitory computer readable media comprising code stored thereon that, when executed, performs a method comprising:
executing a first process that performs first processing including:
creating a first object associated with a first file descriptor of the first process;
the first process crashing including abnormally terminating execution of the first process; and
in response to the first process crashing, performing second processing including:
performing core dump processing of first memory used by the first process; and
starting execution of a second process prior to completing the core dump processing for the first process, wherein the second process performs third processing including:
creating a second file descriptor of the second process, wherein the second file descriptor is associated with the first object that is referenced using the first file descriptor; and
the second process taking over the first object using the second file descriptor.

20. The one or more non-transitory computer readable media of claim 19, wherein the first object is any of a pipe, a file, and a socket.
